(19) United States
(12) Patent Application Publication
(10) Pub. No.: US 2020/0077099 A1
(43) Pub. Date: Mar. 5, 2020

(54) IMAGE DECODING DEVICE AND IMAGE CODING DEVICE

(71) Applicants: Sharp Kabushiki Kaisha, Sakai City, Osaka (JP); FG Innovation Company Limited, Tuen Mun, New Territories (HK)

(72) Inventors: Tomohiro IKAI, Sakai City (JP); Yukinobu YASUGI, Sakai City (JP); Tomoko AONO, Sakai City (JP)

(21) Appl. No.: 16/468,309

(22) PCT Filed: Dec. 8, 2017
(86) PCT No.: PCT/JP2017/044240

§ 371 Date: Jun. 11, 2019

(30) Foreign Application Priority Data
Dec. 16, 2016 (JP) 2016-244900
Mar. 16, 2017 (JP) 2017-051342

(51) Int. Cl. H04N 19/176; H04N 19/13; H04N 19/157; H04N 19/46

(52) U.S. Cl. CPC H04N 19/176; H04N 19/46; H04N 19/157; H04N 19/13

(57) ABSTRACT

An image decoding device includes a context determination unit configured to determine a context of split information of a target block with reference to split-related information of at least one neighboring block adjacent to the target block; and a split information decoding unit configured to decode the split information of the target block by using the context determined by the context determination unit.

### TECHNICAL FIELD

The disclosure relates to an image decoding device and an image coding device.

### BACKGROUND ART

A video encoding device configured to generate coded data by coding a video and a video decoding device configured to generate decoded images by decoding the coded data are used, in order to transmit or record the video efficiently.

As specific video coding schemes, for example, schemes suggested by H.264/AVC and High-Efficiency Video Coding (HEVC), and the like can be cited.

In such a video coding scheme, images (pictures) constituting a video are managed by a hierarchy structure including slices obtained by splitting the images, Coding Tree Units (CTUs) obtained by splitting the slices, coding units (also referred to as Coding Units (CUs) in some cases) obtained by splitting the Coding Tree Units, and prediction units (PUs) and transform units (TUs) as blocks obtained by splitting the coding units, and are coded/decoded for each CU.

In such a video coding scheme, normally, a prediction image is generated based on a local decoded image obtained by coding/decoding an input image, and a prediction residual (also referred to as a “difference image” or “residual image” in some cases) obtained by subtracting the prediction image from the input image (original image) is coded. Generation methods for prediction images include an inter-screen prediction (inter-prediction) and an intra-screen prediction (intra-prediction).

An example of a recent technique of video coding and decoding is described in NPL 1.

Furthermore, in recent years, as a splitting scheme for the CTUs constituting the slices, a BT split in which the CTU is split into binary trees is introduced in addition to a QT split in which the CTU is split into quad trees. The BT split includes a horizontal split and a vertical split.

### CITATION LIST

### Non Patent Literature

NPL 1: “Algorithm Description of Joint Exploration Test Model 5”, JVET-E1001-v1, Joint Video Exploration Team (JVET) of ITU-T SG 16 WP 3 and ISO/IEC JTC 1/SC 29/WG 11, 12-20 Jan. 2017

### SUMMARY

### Technical Problem

However, as a splitting scheme for the CTUs, since the BT split is introduced in addition to the QT split, split patterns of the CTU into CUs are increased and the amount of coding or decoding processing of the video is increased, so that the coding/decoding becomes complicated. In the QT split and the BT split, a QT split flag needs to be coded or decoded and a BT split flag also needs to be coded or decoded. In addition, there is a problem that code amounts of these split flags are large.

An aspect of the disclosure has been conceived in view of the problems described above, and a main object thereof is to provide a technique capable of reducing the code amounts of split information in an image coding device or an image decoding device.

### Solution to Problem

In order to solve the above-described problems, an image decoding device according to an aspect of the disclosure is an image decoding device for decoding a picture for each block, the image decoding device including: a context determination unit configured to determine, with reference to a result of comparison of split-related information of at least one neighboring block adjacent to the target block, a context of split information of the target block; and a split information decoding unit configured to decode the split information of the target block by using the context determined by the context determination unit.

In order to solve the above-described problems, an image coding device according to an aspect of the disclosure is an image coding device for coding a picture for each block, the image coding device including: a context determination unit configured to determine, with reference to a result of comparison of split-related information of at least one neighboring block adjacent to the target block, a context of split information of the target block; and a split information coding unit configured to code the split information of the target block by using the context determined by the context determination unit.

In order to solve the above-described problems, an image decoding device according to an aspect of the disclosure is an image decoding device for decoding a picture for each block, the image decoding device including: a context determination unit configured to determine a context of split information of a target block with reference to a split situation of at least one neighboring block adjacent to the target block; and a split information decoding unit configured to decode the split information of the target block by using the context determined by the context determination unit.

In order to solve the above-described problems, an image coding device according to an aspect of the disclosure is an image coding device for coding a picture for each block, the image coding device including: a context determination unit configured to determine a context of split information of a target block with reference to a split situation of at least one neighboring block adjacent to the target block; and a split information coding unit configured to code the split information of the target block by using the context determined by the context determination unit.

In order to solve the above-described problems, an image decoding device according to an aspect of the disclosure is an image decoding device for decoding a picture for each block, the image decoding device including: a context determination unit configured to determine a context of split information of a target block relating to a first color component with reference to a split situation of a corresponding block relating to a second color component which is already decoded; and a split information decoding unit configured to decode the split information of the target block relating to the first color component by using the context determined by the context determination unit.

In order to solve the above-described problems, an image coding device according to an aspect of the disclosure is an image coding device for coding a picture for each block, the image coding device including: a context determination unit configured to determine a context of split information of a target block relating to a first color component with reference to a split situation of a corresponding block relating to a second color component which is already decoded; and a split information coding unit configured to code the split information of the target block relating to the first color component by using the context determined by the context determination unit.

### Advantageous Effects of Invention

According to an aspect of the disclosure, in the image decoding device, the code amounts of split information can be reduced.

### BRIEF DESCRIPTION OF DRAWINGS

FIG. 1 is a schematic diagram illustrating a configuration of an image transmission system according to the present embodiment.

FIGS. 2A to 2F are diagrams illustrating a hierarchy structure of data of a coding stream according to the present embodiment.

FIGS. 3A to 3H are diagrams illustrating patterns of PU split modes. FIGS. 3A to 3H indicate partition shapes in cases that the PU split modes are 2N×2N, 2N×N, 2N×nU, 2N×nD, N×2N, nL×2N, nR×2N, and N×N, respectively.

FIGS. 4A and 4B are conceptual diagrams illustrating an example of reference pictures and reference picture lists.

FIG. 5 is a block diagram illustrating a configuration of an image coding device according to the present embodiment.

FIG. 6 is a schematic diagram illustrating a configuration of an image decoding device according to the present embodiment.

FIG. 7 is a block diagram illustrating a configuration of a main portion of an image coding device according to the present embodiment.

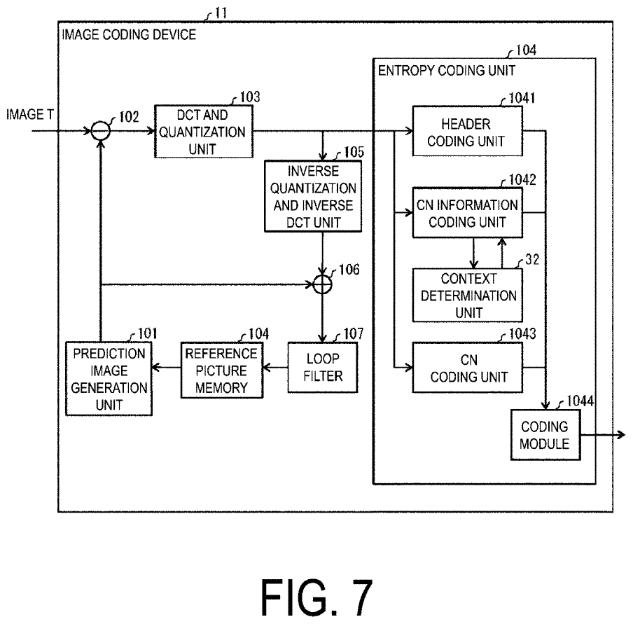

FIGS. 8A and 8B are diagrams illustrating configurations of a transmitting apparatus equipped with an image coding device and a receiving apparatus equipped with an image decoding device according to the present embodiment. FIG. 8A illustrates the transmitting apparatus equipped with the image coding device, and FIG. 8B illustrates the receiving apparatus equipped with the image decoding device.

FIGS. 9A and 9B are diagrams illustrating configurations of a recording apparatus equipped with an image coding device and a regeneration apparatus equipped with an image decoding device according to the present embodiment. FIG. 9A illustrates the recording apparatus equipped with the image coding device, and FIG. 9B illustrates the regeneration apparatus equipped with the image decoding device.

FIG. 10 is a block diagram illustrating a configuration of a main portion of an image decoding device according to the present embodiment.

FIG. 11A is a diagram illustrating a QT split. FIG. 11B is a diagram for explaining a BT split. FIG. 11C is a diagram illustrating a TT split.

FIG. 12 is a flowchart illustrating a context determination method performed by an image decoding device according to an embodiment of the disclosure.

FIG. 13 is a diagram illustrating a context determination method performed by an image decoding device according to an embodiment of the disclosure.

FIG. 14 is a diagram illustrating a first specific example of a context determination method performed by an image decoding device according to an embodiment of the disclosure.

FIG. 15 is a diagram illustrating a second specific example of a context determination method performed by an image decoding device according to an embodiment of the disclosure.

FIG. 16 is a diagram illustrating a third specific example of a context determination method performed by an image decoding device according to an embodiment of the disclosure.

FIGS. 17A to 17C are diagrams illustrating a depth of a target block and a neighboring block.

FIG. 18 is a diagram illustrating a specific example of a context determination method according to an embodiment of the disclosure.

FIGS. 19A and 19B are examples, each illustrating a relationship between a split and a depth of a target block and a neighboring block.

FIGS. 20A and 20B are diagrams illustrating positions of a target block and a neighboring block.

FIG. 21 is a flowchart illustrating a specific example of a context determination method according to an embodiment of the disclosure.

FIGS. 22A to 22C are flowcharts, each illustrating a clipping process according to an embodiment of the disclosure.

FIG. 23 is an example of a mapping table illustrating an addition result or a maximum value of difference values of split-related information and a context in a context determination method according to an embodiment of the disclosure.

FIG. 24 is a flowchart illustrating a context determination method performed by an image decoding device according to an embodiment of the disclosure.

FIGS. 25A and 25B are diagrams illustrating a first specific example of a context determination method performed by an image decoding device according to an embodiment of the disclosure. FIG. 25A illustrates a chrominance block. FIG. 25B illustrates a luminance block.

FIGS. 26A and 26B are diagrams illustrating a second specific example of a context determination method performed by an image decoding device according to an embodiment of the disclosure. FIG. 26A illustrates a chrominance block. FIG. 26B illustrates a luminance block.

FIGS. 27A and 27B are diagrams illustrating a third specific example of a context determination method performed by an image decoding device according to an embodiment of the disclosure. FIG. 27A illustrates a chrominance block. FIG. 27B illustrates a luminance block.

FIG. 28 is a flowchart illustrating a context determination method performed by an image decoding device according to an aspect of the disclosure.

FIGS. 29A to 29D are tables illustrating specific examples of a context determination method performed by an image decoding device according to an embodiment of the disclosure.

FIG. 30 is a flowchart illustrating a context determination method performed by an image decoding device according to an aspect of the disclosure.

### DESCRIPTION OF EMBODIMENTS

### First Embodiment

Hereinafter, embodiments of the disclosure are described with reference to the drawings.

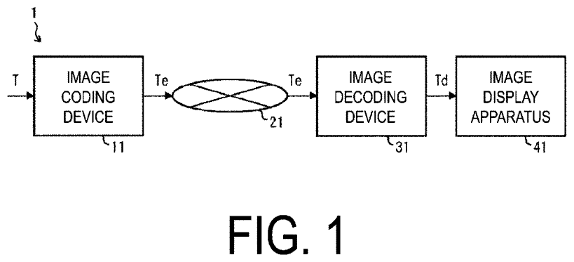

FIG. 1 is a schematic diagram illustrating a configuration of an image transmission system 1 according to the present embodiment.

The image transmission system 1 is a system configured to transmit codes of a coding target image having been coded, decode the transmitted codes, and display an image. The image transmission system 1 is configured to include an image coding device 11, a network 21, an image decoding device 31, and an image display apparatus 41.

An image T indicating an image of a single layer or a plurality of layers is input to the image coding device 11. A layer is a concept used to distinguish a plurality of pictures in a case that there are one or more pictures to configure a certain time. For example, coding an identical picture in the plurality of layers having different image qualities and resolutions is scalable coding, and coding pictures having different viewpoints in the plurality of layers is view scalable coding. In a case of performing a prediction (an inter-layer prediction, an inter-view prediction) between pictures in the plurality of layers, coding efficiency greatly improves. In a case of not performing a prediction (simulcast), coded data can be compiled.

The network 21 transmits a coding stream Te generated by the image coding device 11 to the image decoding device 31. The network 21 is the Internet, a Wide Area Network (WAN), a Local Area Network (LAN), or a combination thereof. The Network 21 is not necessarily a bidirectional communication network, but may be a unidirectional communication network configured to transmit broadcast wave such as digital terrestrial television broadcasting and satellite broadcasting. The network 21 may be substituted with a storage medium having recorded therein the coding stream Te, such as a Digital Versatile Disc (DVD) or Blu-ray Disc (registered trademark) (BD).

The image decoding device 31 decodes each of the coding streams Te transmitted by the network 21, and generates one or a plurality of decoded images Td.

The image display apparatus 41 displays all or part of one or the plurality of decoded images Td generated by the image decoding device 31. For example, the image display apparatus 41 includes a display device such as a liquid crystal display or an organic Electro-luminescence (EL) display. In special scalable coding and SNR scalable coding, in a case that the image decoding device 31 and the image display apparatus 41 have high processing capability, an enhanced layer image having high image quality is displayed, and in a case of having lower processing capability, a base layer image which does not require as high processing capability and display capability as an enhanced layer is displayed.

### Operator

Operators used herein will be described below.

>> is a right bit shift, << is a left bit shift, & is a bitwise AND, | is bitwise OR, and |= is a sum operation (OR) with another condition.

x?y:z is a ternary operator to take y in a case that x is true (other than 0), and take z in a case that x is false (0).

Clip3 (a, b, c) is a function to clip c in a value equal to or greater than a and equal to or less than b, and a function to return a in a case that c is less than a (c<a), return b in a case that c is greater than b (c>b), and return c otherwise (however, a is equal to or less than b (a<=b)).

### Structure of Coding Stream Te

Prior to the detailed description of the image coding device 11 and the image decoding device 31 according to the present embodiment, the data structure of the coding stream Te generated by the image coding device 11 and decoded by the image decoding device 31 will be described.

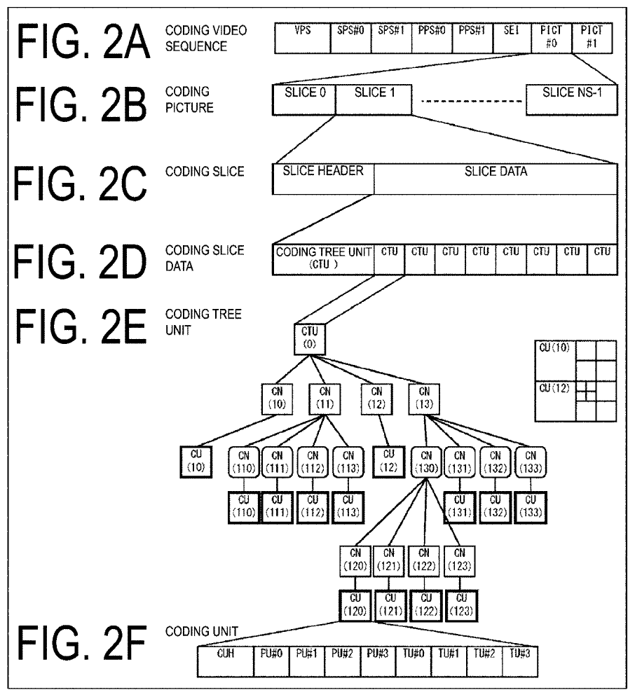

FIGS. 2A to 2F are diagrams illustrating the hierarchy structure of data in the coding stream Te. The coding stream Te includes a sequence and a plurality of pictures constituting the sequence, illustratively. FIGS. 2A to 2F are diagrams indicating a coding video sequence prescribing a sequence SEQ, a coding picture prescribing a picture PICT, a coding slice prescribing a slice S, a coding slice data prescribing slice data, a coding tree unit included in coding slice data, and coding units (CUs) included in a coding tree unit, respectively.

### Coding Video Sequence

In the coding video sequence, a set of data referred to by the image decoding device 31 to decode the sequence SEQ of a processing target is prescribed. As illustrated in FIG. 2A, the sequence SEQ includes a Video Parameter Set, a Sequence Parameter Set (SPS), a Picture Parameter Set (PPS), a picture PICT, and Supplemental Enhancement Information (SEI). Here, a value indicated after # indicates a layer ID. In FIGS. 2A to 2F, although an example is illustrated where coding data of #0 and #1, in other words, layer 0 and layer 1 exists, types of layers and the number of layers are not limited thereto.

In the Video Parameter Set VPS, in a video constituted by the plurality of layers, a set of coding parameters common to the plurality of videos, and a set of coding parameters associated with the plurality of layers and an individual layer included in the video are prescribed.

In the Sequence Parameter Set SPS, a set of coding parameters referred to by the image decoding device 31 to decode a target sequence is prescribed. For example, width and height of a picture are prescribed. Note that the plurality of SPSs may exist. In that case, any of the plurality of SPSs is selected from the PPS.

In the Picture Parameter Set PPS, a set of coding parameters referred to by the image decoding device 31 to decode each picture in a target sequence is prescribed. For example, a reference value (pic_init_qp_minus26) of a quantization step size used for decoding of a picture and a flag (weighted_pred_flag) indicating an application of a weighted prediction are included. Note that the plurality of PPSs may exist. In that case, any of the plurality of PPSs is selected from each picture in a target sequence.

### Coding Picture

In the coding picture, a set of data referred to by the image decoding device 31 to decode the picture PICT of a processing target is prescribed. As illustrated in FIG. 2B, the picture PICT includes slices S0 to SNS−1 (NS is the total number of slices included in the picture PICT).

Hereinafter, in a case that it is not necessary to distinguish the slices S0 to SNS−1 from each other, reference signs may be described with subscripts omitted. The same applies to data included in the coding stream Te described below and described with an added subscript.

### Coding Slice

In the coding slice, a set of data referred to by the image decoding device 31 to decode the slice S of a processing target is prescribed. As illustrated in FIG. 2C, the slice S includes a slice header SH and a slice data SDATA.

The slice header SH includes a coding parameter group referred to by the image decoding device 31 to determine a decoding method of a target slice. Slice type specification information (slice_type) to specify a slice type is one example of a coding parameter included in the slice header SH.

Examples of slice types that can be specified by the slice type specification information include: (1) an I slice using only an intra-prediction in coding; (2) a P slice using a unidirectional prediction or an intra-prediction in coding; and (3) a B slice using a unidirectional prediction, a bidirectional prediction, or an intra-prediction in coding.

Note that, the slice header SH may include a reference (pic_parameter_set_id) to the Picture Parameter Set PPS included in the coding video sequence.

### Coding Slice Data

In the coding slice data, a set of data referred to by the image decoding device 31 to decode the slice data SDATA of a processing target is prescribed. As illustrated in FIG. 2D, the slice data SDATA includes Coding Tree Units (CTUs). The CTU is a fixed size (for example, 64×64) block constituting a slice, and may be referred to as a Largest Coding Unit (LCU).

### Coding Tree Unit

As illustrated in FIG. 2E, a set of data referred to by the image decoding device 31 to decode a coding tree unit of a processing target is prescribed. The coding tree unit is split by a recursive quad tree split (QT split) or binary tree split (BT split). Nodes of a tree structure obtained by the recursive quad tree split or binary tree split are referred to as Coding Nodes (CNs). Intermediate nodes of quad trees and binary trees are a Coding Tree (CT), and a Coding Tree unit itself is also prescribed as a highest level Coding Tree.

The CTU includes a QT split flag (cu_split_flag) indicating whether or not to perform a QT split, and a BT split mode (split_bt_mode) indicating a split method of the BT split. In a case that cu_split_flag is 1, the CTU is split into four coding node CNs. In a case that cu_split_flag is 0, the coding node CN is not split, and has one Coding Unit (CU) as a node. On the other hand, in a case that split_bt_mode is 2, the CN is split into two coding nodes CNs by a horizontal split (a split by a horizontal split line into two or more blocks of upper and lower sides). In a case that split_bt_mode is 1, the CN is split into two coding nodes CNs by a vertical split (a split by a vertical line into two or more blocks of left and right sides in this case). In a case that split_bt_mode is 0, the coding node CN is not split, and has one coding unit CU as a node. Since a certain block is split into two or more blocks arranged in a vertical direction, the horizontal split is also referred to as “to split vertically”. Likewise, since a certain block is split into two or more blocks arranged in a horizontal direction, the vertical split is also referred to as “to split horizontally”. In summary, the definitions of the terms are as follows.

Horizontal split=to split vertically=to split in an up-down direction

Vertical split=to split horizontally=to split in a left-right direction

The coding unit CU is an end node (leaf node) of the coding nodes, and is not split any more. The coding unit CU is a basic unit of coding processing.

Further, in a case that the size of the coding tree unit CTU is 64×64 pixels, the size of the coding unit can take any of 64×64 pixels, 64×32 pixels, 32×64 pixels, 32×32 pixels, 64×16 pixels, 16×64 pixels, 32×16 pixels, 16×32 pixels, 16×16 pixels, 64×8 pixels, 8×64 pixels, 32×8 pixels, 8×32 pixels, 16×8 pixels, 8×16 pixels, and 8×8 pixels.

### Coding Unit

As illustrated in FIG. 2F, a set of data referred to by the image decoding device 31 to decode the coding unit of a processing target is prescribed. Specifically, the coding unit is constituted by a prediction tree, a transform tree, and a CU header CUH. In the CU header, a prediction mode, a split method (PU split mode), and the like are prescribed.

In the prediction tree, prediction information (a reference picture index, a motion vector, and the like) of each prediction unit (PU) where the coding unit is split into one or a plurality of pieces is prescribed. In another expression, the prediction unit is one or the plurality of non-overlapping regions constituting the coding unit. The prediction tree includes one or the plurality of prediction units obtained by the above-mentioned split. Note that, in the following, a unit of prediction where the prediction unit is further split is referred to as a “subblock”. The subblock is constituted by a plurality of pixels. In a case that sizes of the prediction unit and the subblock are equal, there is one subblock in the prediction unit. In a case that the prediction unit is larger than a size of the subblock, the prediction unit is split into subblocks. For example, in a case that the prediction unit is 8×8, and the subblock is 4×4, the prediction unit is split into four subblocks formed by two horizontal splits and two vertical splits.

The prediction processing may be performed for each of these prediction units (subblocks).

Generally speaking, there are two types of splits in the prediction tree including a case of an intra-prediction and a case of an inter-prediction. The intra-prediction is a prediction in an identical picture, and the inter-prediction refers to a prediction processing performed between mutually different pictures (for example, between display times, and between layer images).

In a case of an intra-prediction, the split method has 2N×2N (the same size as the coding unit) and N×N.

In a case of an inter-prediction, the split method includes coding by a PU split mode (part_mode) of the coding data, and includes 2N×2N (the same size as the coding unit), 2N×N, 2N×nU, 2N×nD, N×2N, nL×2N, nR×2N, N×N, and the like. Note that 2N×N and N×2N each indicate a symmetrical split of 1:1, while 2N×nU, 2N×nD and nL×2N, nR×2N indicate dissymmetry splits of 1:3 and 3:1. The PUs included in the CU are expressed as PU0, PU1, PU2, and PU3 sequentially.

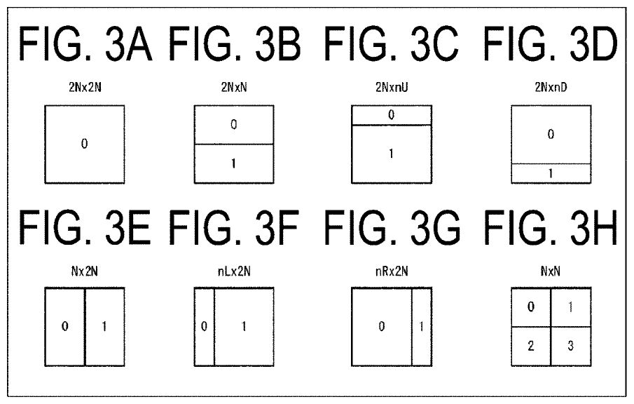

FIGS. 3A to 3H illustrate shapes of partitions in respective PU split modes (positions of boundaries of PU splits) specifically. FIG. 3A indicates a partition of 2N×2N, and FIGS. 3B, 3C, and 3D indicate partitions (horizontally long partitions) of 2N×N, 2N×nU, and 2N×nD, respectively. FIGS. 3E, 3F, and 3G indicate partitions (vertically long partitions) in cases of N×2N, nL×2N, and nR×2N, respectively, and FIG. 3H indicates a partition of N×N. Note that horizontally long partitions and vertically long partitions are collectively referred to as rectangular partitions, and 2N×2N and N×N are collectively referred to as square partitions.

In a Transform Tree (TT), the coding unit is split into one or a plurality of Transform Units (TUs), and a position and a size of each Transform Unit are prescribed. In another expression, the Transform Unit is one or the plurality of non-overlapping regions constituting the coding unit. The Transform Tree includes one or the plurality of Transform Units obtained by the above-mentioned splits.

The splits in the Transform Tree include splits to allocate a region that is the same in size as the coding unit as a Transform Unit, and splits to obtain a Transform Unit by performing the quad tree split (TU split) on the CU similarly to the above-mentioned splits of CUs. Transform processing is performed for each of the Transform Units.

### Prediction Parameter

A prediction image of Prediction Units (PUs) is derived by prediction parameters attached to the PUs. The prediction parameter includes a prediction parameter of an intra-prediction or a prediction parameter of an inter-prediction. The prediction parameter of an inter-prediction (inter-prediction parameters) will be described below. The inter-prediction parameter is constituted by prediction list utilization flags predFlagL0 and predFlagL1, reference picture indexes refIdxL0 and refIdxL1, and motion vectors mvL0 and mvL1. The prediction list utilization flags predFlagL0 and predFlagL1 are flags to indicate whether or not reference picture lists referred to as L0 list and L1 list respectively are used, and a corresponding reference picture list is used in a case that the value is 1. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive inter-prediction parameters included in a coded data include a PU split mode part_mode, a merge flag merge_flag, a merge index merge_idx, an inter-prediction indicator inter_pred_idc, a reference picture index refIdxLX, a prediction vector index mvp_LX_idx, and a difference vector mvdLX.

### Reference Picture List

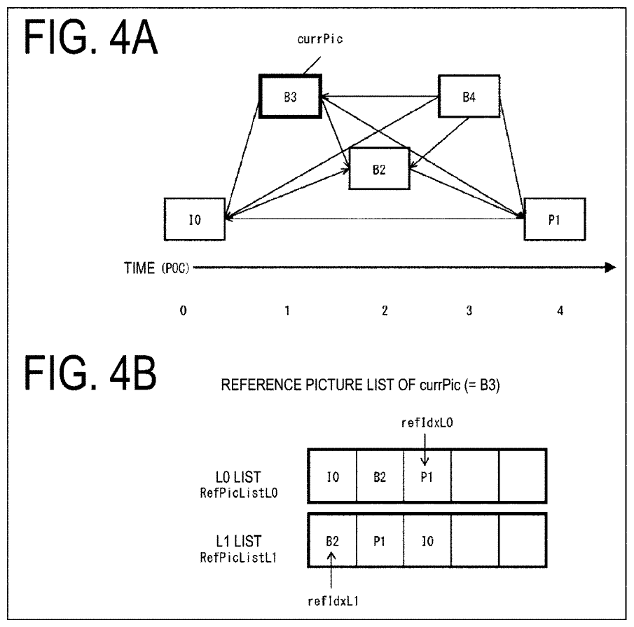

A reference picture list is a list constituted by reference pictures stored in a reference picture memory 306. FIGS. 4A and 4B are conceptual diagrams illustrating an example of reference pictures and reference picture lists. In FIG. 4A, a rectangle indicates a picture, an arrow indicates a reference relationship of a picture, a horizontal axis indicates time, each of I, P, and B in a rectangle indicates an intra-picture, a uni-prediction picture, a bi-prediction picture, and a number in a rectangle indicates a decoding order. As illustrated, the decoding order of the pictures is I0, P1, B2, B3, and B4, and the display order is I0, B3, B2, B4, and P1. FIG. 4B indicates an example of reference picture lists. The reference picture list is a list to represent a candidate of a reference picture, and one picture (slice) may include one or more reference picture lists. In an example of the drawing, a target picture B3 includes two reference picture lists, i.e., an L0 list RefPicList0 and an L1 list RefPicList1. In a case that a target picture is B3, the reference pictures are I0, P1, and B2, and the reference picture includes these pictures as elements. For an individual prediction unit, which picture in a reference picture list RefPicListX is actually referred to is specified with a reference picture index refIdxLX. The diagram indicates an example where the reference pictures P1 and B2 are referred to by refIdxL0 and refIdxL1.

### Merge Prediction and AMVP Prediction

Decoding (coding) methods of prediction parameters include a merge prediction (merge) mode and an Adaptive Motion Vector Prediction (AMVP) mode, and a merge flag merge_flag is a flag to identify these. The merge prediction mode is a mode to use, without including a prediction list utilization flag predFlagLX (or an inter-prediction indicator inter_pred_idc), a reference picture index refIdxLX, and a motion vector mvLX in coding data, to derive from prediction parameters of neighbor PUs having already been processed, while the AMVP mode is a mode to include an inter-prediction indicator inter_pred_idc, a reference picture index refIdxLX, and a motion vector mvLX in coding data. Note that, the motion vector mvLX is coded as a prediction vector index mvp_LX_idx identifying a prediction vector mvpLX and a difference vector mvdLX.

The inter-prediction indicator inter_pred_idc is a value indicating types and the number of reference pictures, and takes any value of PRED_L0, PRED_L1, and PRED_BI. PRED_L0 and PRED_L1 indicate to use reference pictures managed in the reference picture list of the L0 list and the L1 list respectively, and indicate to use one reference picture (uni-prediction). PRED_BI indicates to use two reference pictures (bi-prediction BiPred), and use reference pictures managed in the L0 list and the L1 list. The prediction vector index mvp_LX_idx is an index indicating a prediction vector, and the reference picture index refIdxLX is an index indicating reference pictures managed in a reference picture list. Note that LX is a description method used in a case of not distinguishing the L0 prediction and the L1 prediction, and distinguishes parameters for the L0 list and parameters for the L1 list by replacing LX with L0 and L1.

The merge index merge_idx is an index to indicate to use either prediction parameter as a prediction parameter of a decoding target PU among prediction parameter candidates (merge candidates) derived from PUs of which the processing is completed.

### Motion Vector

The motion vector mvLX indicates a gap quantity between blocks in two different pictures. A prediction vector and a difference vector related to the motion vector mvLX are referred to as a prediction vector mvpLX and a difference vector mvdLX respectively.

Inter-Prediction Indicator inter_pred_idc and Prediction List Utilization Flag predFlagLX

Relationships between an inter-prediction indicator inter_pred_idc and prediction list utilization flags predFlagL0 and predFlagL1 are as follows, and those can be converted mutually.

inter_pred_idc=(predFlagL1<<1)+predFlagL0

predFlagL0=inter_pred_idc & 1

predFlagL1=inter_pred_idc>>1

Note that an inter-prediction parameter may use a prediction list utilization flag or may use an inter-prediction indicator. A determination using a prediction list utilization flag may be replaced with a determination using an inter-prediction indicator. On the contrary, a determination using an inter-prediction indicator may be replaced with a determination using a prediction list utilization flag.

Determination of Bi-Prediction biPred

A flag biPred of whether or not a bi-prediction BiPred can be derived from whether or not two prediction list utilization flags are both 1. For example, the flag can be derived by the following equation.

biPred=(predFlagL0==1 && predFlagL1==1)

The flag biPred can be also derived from whether an inter-prediction indicator is a value indicating to use two prediction lists (reference pictures). For example, the flag can be derived by the following equation.

biPred=(inter_pred_idc==PRED_BI)?1:0

The equation can be also expressed with the following equation.

biPred=(inter_pred_idc==PRED_BI)

Note that, for example, PRED_BI can use the value of 3.

### Configuration of Image Decoding Device

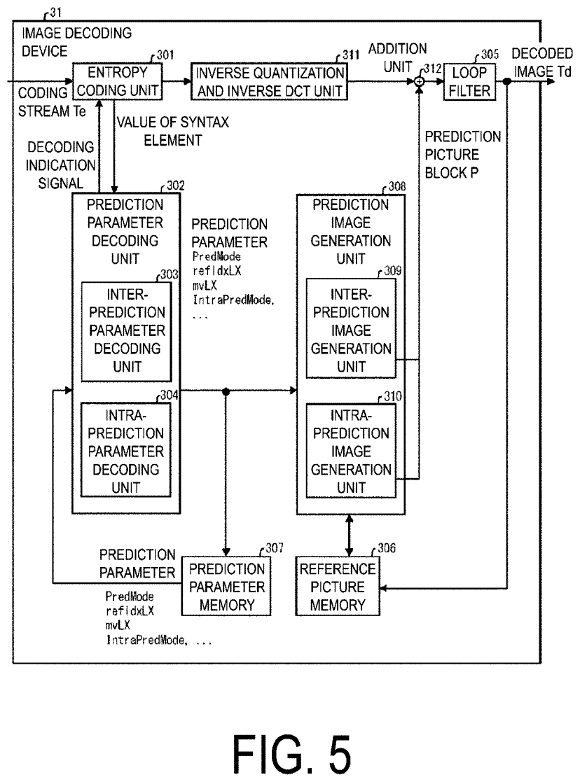

A configuration of the image decoding device 31 according to the present embodiment will now be described. FIG. 5 is a schematic diagram illustrating the configuration of the image decoding device 31 according to the present embodiment. The image decoding device 31 is configured to include an entropy decoding unit 301, a prediction parameter decoding unit (a prediction image decoding device) 302, a loop filter 305, the reference picture memory 306, a prediction parameter memory 307, a prediction image generation unit (prediction image generation device) 308, an inverse quantization and inverse DCT unit 311, and an addition unit 312.

The prediction parameter decoding unit 302 is configured to include an inter-prediction parameter decoding unit 303 and an intra-prediction parameter decoding unit 304. The prediction image generation unit 308 is configured to include an inter-prediction image generation unit 309 and an intra-prediction image generation unit 310.

The entropy decoding unit 301 performs entropy decoding on the coding stream Te input from the outside, and separates and decodes individual codes (syntax elements). The separated codes include prediction information to generate a prediction image, residual information to generate a difference image, and the like.

The entropy decoding unit 301 outputs a part of the separated codes to the prediction parameter decoding unit 302. For example, a part of the separated codes includes a prediction mode predMode, a PU split mode part_mode, a merge flag merge_flag, a merge index merge_idx, an inter-prediction indicator inter_pred_idc, a reference picture index refIdxLX, a prediction vector index mvp_LX_idx, and a difference vector mvdLX. The control on which code to decode is performed based on an indication of the prediction parameter decoding unit 302. The entropy decoding unit 301 outputs quantization coefficients to the inverse quantization and inverse DCT unit 311. These quantization coefficients are coefficients obtained by performing Discrete Cosine Transform (DCT) on a residual signal to achieve quantization in coding processing.

The inter-prediction parameter decoding unit 303 decodes an inter-prediction parameter with reference to a prediction parameter stored in the prediction parameter memory 307 based on a code input from the entropy decoding unit 301.

The inter-prediction parameter decoding unit 303 outputs a decoded inter-prediction parameter to the prediction image generation unit 308, and also stores the decoded inter-prediction parameter in the prediction parameter memory 307. Details of the inter-prediction parameter decoding unit 303 will be described below.

The intra-prediction parameter decoding unit 304 decodes an intra-prediction parameter with reference to a prediction parameter stored in the prediction parameter memory 307 based on a code input from the entropy decoding unit 301. The intra-prediction parameter is a parameter used in the processing to predict a CU in one picture, for example, an intra-prediction mode IntraPredMode. The intra-prediction parameter decoding unit 304 outputs a decoded intra-prediction parameter to the prediction image generation unit 308, and also stores the decoded intra-prediction parameter in the prediction parameter memory 307.

The intra-prediction parameter decoding unit 304 may derive different intra-prediction modes for luminance and chrominance. In this case, the intra-prediction parameter decoding unit 304 decodes a luminance prediction mode IntraPredModeY as a prediction parameter of luminance, and decodes a chrominance prediction mode IntraPredModeC as a prediction parameter of chrominance. The luminance prediction mode IntraPredModeY includes 35 modes, and corresponds to a planar prediction (0), a DC prediction (1), directional predictions (2 to 34). The chrominance prediction mode IntraPredModeC uses any of a planar prediction (0), a DC prediction (1), directional predictions (2 to 34), and a LM mode (35). The intra-prediction parameter decoding unit 304 may decode a flag indicating whether IntraPredModeC is a mode identical to the luminance mode, assign IntraPredModeY to IntraPredModeC in a case of indicating that the flag is the mode identical to the luminance mode, and decode a planar prediction (0), a DC prediction (1), directional predictions (2 to 34), and a LM mode (35) as IntraPredModeC in a case of indicating that the flag is a mode different from the luminance mode.

The loop filter 305 applies a filter such as a deblocking filter, a sample adaptive offset (SAO), and an adaptive loop filter (ALF) on a decoded image of a CU generated by the addition unit 312.

The reference picture memory 306 stores a decoded image of a CU generated by the addition unit 312 in a prescribed position for each picture and CU of a decoding target.

The prediction parameter memory 307 stores a prediction parameter in a prescribed position for each picture and prediction unit (or a subblock, a fixed size block, and a pixel) of a decoding target. Specifically, the prediction parameter memory 307 stores an inter-prediction parameter decoded by the inter-prediction parameter decoding unit 303, an intra-prediction parameter decoded by the intra-prediction parameter decoding unit 304, and a prediction mode predMode separated by the entropy decoding unit 301. For example, inter-prediction parameters stored include a prediction list utilization flag predFlagLX (the inter-prediction indicator inter_pred_idc), a reference picture index refIdxLX, and a motion vector mvLX.

A prediction mode predMode input from the entropy decoding unit 301 is input, and a prediction parameter is input from the prediction parameter decoding unit 302, to the prediction image generation unit 308. The prediction image generation unit 308 reads a reference picture from the reference picture memory 306. The prediction image generation unit 308 generates a prediction image of a PU using a prediction parameter input and a reference picture read with a prediction mode indicated by the prediction mode predMode.

Here, in a case that the prediction mode predMode indicates an inter-prediction mode, the inter-prediction image generation unit 309 generates a prediction image of a PU by an inter-prediction using an inter-prediction parameter input from the inter-prediction parameter decoding unit 303 and a read reference picture.

For a reference picture list (an L0 list or a L1 list) where a prediction list utilization flag predFlagLX is 1, the inter-prediction image generation unit 309 reads a reference picture block from the reference picture memory 306 in a position indicated by a motion vector mvLX based on a decoding target PU, from reference pictures indicated by the reference picture index refIdxLX. The inter-prediction image generation unit 309 performs a prediction based on a read reference picture block and generates a prediction image of a PU. The inter-prediction image generation unit 309 outputs the generated prediction image of the PU to the addition unit 312.

In a case that the prediction mode predMode indicates an intra-prediction mode, the intra-prediction image generation unit 310 performs an intra-prediction using an intra-prediction parameter input from the intra-prediction parameter decoding unit 304 and a read reference picture. Specifically, the intra-prediction image generation unit 310 reads out, from the reference picture memory 306, a neighboring PU within a prescribed range from the decoding target PU among the PUs, as a decoding target picture, which have already been decoded. The prescribed range refers to, for example, any of neighboring PUs on the left, upper left, upper, and upper right sides in a case that the decoding target PU is sequentially moved in the so-called raster scan order, and differs depending on intra-prediction modes. The raster scan order is an order in which the PU is sequentially moved from the left end to the right end at each row from the upper end to the lower end for each picture.

The intra-prediction image generation unit 310 performs a prediction in a prediction mode indicated by the intra-prediction mode IntraPredMode for a read neighboring PU, and generates a prediction image of a PU. The intra-prediction image generation unit 310 outputs the generated prediction image of the PU to the addition unit 312.

In a case that the intra-prediction parameter decoding unit 304 derives different intra-prediction modes with luminance and chrominance, the intra-prediction image generation unit 310 generates a prediction image of a PU of luminance by any of a planar prediction (0), a DC prediction (1), and directional predictions (2 to 34) depending on a luminance prediction mode IntraPredModeY, and generates a prediction image of a PU of chrominance by any of a planar prediction (0), a DC prediction (1), directional predictions (2 to 34), and LM mode (35) depending on a chrominance prediction mode IntraPredModeC.

The inverse quantization and inverse DCT unit 311 inverse-quantizes quantization coefficients input from the entropy decoding unit 301 and calculates DCT coefficients. The inverse quantization and inverse DCT unit 311 performs Inverse Discrete Cosine Transform (inverse DCT) with respect to the calculated DCT coefficients, and calculates a residual signal. The inverse quantization and inverse DCT unit 311 outputs the calculated residual signal to the addition unit 312.

The addition unit 312 adds a prediction image of a PU input from the inter-prediction image generation unit 309 or the intra-prediction image generation unit 310 and a residual signal input from the inverse quantization and inverse DCT unit 311 for every pixel, and generates a decoded image of a PU. The addition unit 312 stores the generated decoded image of a PU in the reference picture memory 306, and outputs a decoded image Td where the generated decoded image of the PU is integrated for every picture to the outside.

### Configuration of Image Coding Device

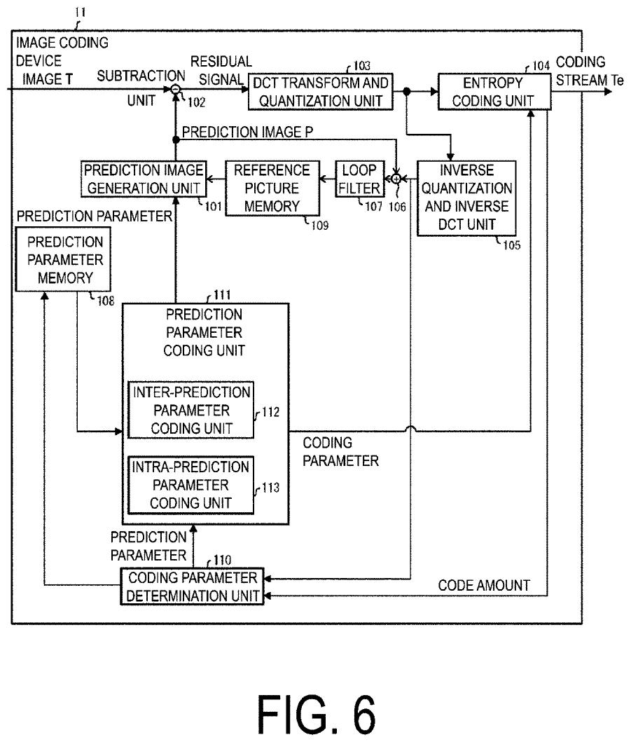

A configuration of the image coding device 11 according to the present embodiment will now be described. FIG. 6 is a block diagram illustrating a configuration of the image coding device 11 according to the present embodiment. The image coding device 11 is configured to include a prediction image generation unit 101, a subtraction unit 102, a DCT and quantization unit 103, an entropy coding unit 104, an inverse quantization and inverse DCT unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, and a prediction parameter coding unit 111. The prediction parameter coding unit 111 is configured to include an inter-prediction parameter coding unit 112 and an intra-prediction parameter coding unit 113.

For each picture of an image T, the prediction image generation unit 101 generates a prediction image P of a prediction unit PU for each coding unit CU that is a region where the picture is split. Here, the prediction image generation unit 101 reads a block that has been decoded from the reference picture memory 109, based on a prediction parameter input from the prediction parameter coding unit 111. For example, in a case of an inter-prediction, the prediction parameter input from the prediction parameter coding unit 111 is a motion vector. The prediction image generation unit 101 reads a block in a position in a reference image indicated by a motion vector starting from a target PU. In a case of an intra-prediction, the prediction parameter is, for example, an intra-prediction mode. The prediction image generation unit 101 reads a pixel value of a neighboring PU used in an intra-prediction mode from the reference picture memory 109, and generates the prediction image P of a PU. The prediction image generation unit 101 generates the prediction image P of a PU using one prediction scheme among a plurality of prediction schemes for the read reference picture block. The prediction image generation unit 101 outputs the generated prediction image P of a PU to the subtraction unit 102.

Note that the prediction image generation unit 101 operates in the same manner as the prediction image generation unit 308 having already been described.

The prediction image generation unit 101 generates the prediction image P of a PU based on a pixel value of a reference block read from the reference picture memory by using a parameter input by the prediction parameter coding unit. The prediction image generated by the prediction image generation unit 101 is output to the subtraction unit 102 and the addition unit 106.

The subtraction unit 102 subtracts a signal value of the prediction image P of a PU input from the prediction image generation unit 101 from a pixel value of a corresponding PU of the image T, and generates a residual signal. The subtraction unit 102 outputs the generated residual signal to the DCT and quantization unit 103.

The DCT and quantization unit 103 performs a DCT for the residual signal input from the subtraction unit 102, and calculates DCT coefficients. The DCT and quantization unit 103 quantizes the calculated DCT coefficients to calculate quantization coefficients. The DCT and quantization unit 103 outputs the calculated quantization coefficients to the entropy coding unit 104 and the inverse quantization and inverse DCT unit 105.

To the entropy coding unit 104, quantization coefficients are input from the DCT and quantization unit 103, and coding parameters are input from the prediction parameter coding unit 111. For example, input coding parameters include codes such as a reference picture index refIdxLX, a prediction vector index mvp_LX_idx, a difference vector mvdLX, a prediction mode predMode, and a merge index merge_idx.

The entropy coding unit 104 entropy-codes the input quantization coefficients and coding parameters to generate the coding stream Te, and outputs the generated coding stream Te to the outside.

The inverse quantization and inverse DCT unit 105 inverse-quantizes the quantization coefficients input from the DCT and quantization unit 103 to calculate DCT coefficients. The inverse quantization and inverse DCT unit 105 performs inverse DCT on the calculated DCT coefficient to calculate residual signals. The inverse quantization and inverse DCT unit 105 outputs the calculated residual signals to the addition unit 106.

The addition unit 106 adds signal values of the prediction image P of the PUs input from the prediction image generation unit 101 and signal values of the residual signals input from the inverse quantization and inverse DCT unit 105 for every pixel, and generates the decoded image. The addition unit 106 stores the generated decoded image in the reference picture memory 109.

The loop filter 107 applies a deblocking filter, a sample adaptive offset (SAO), and an adaptive loop filter (ALF) to the decoded image generated by the addition unit 106.

The prediction parameter memory 108 stores the prediction parameters generated by the coding parameter determination unit 110 for every picture and CU of the coding target in a prescribed position.

The reference picture memory 109 stores the decoded image generated by the loop filter 107 for every picture and CU of the coding target in a prescribed position.

The coding parameter determination unit 110 selects one set among a plurality of sets of coding parameters. The coding parameter is the above-mentioned prediction parameter or a parameter to be a target of coding generated associated with the prediction parameter. The prediction image generation unit 101 generates the prediction image P of the PUs using each of the sets of these coding parameters.

The coding parameter determination unit 110 calculates cost values indicating a volume of an information quantity and coding errors for each of the plurality of sets. For example, a cost value is a sum of a code amount and a value of multiplying a coefficient λ by a square error. The code amount is an information quantity of the coding stream Te obtained by entropy coding a quantization error and a coding parameter. The square error is a sum total of square values of residual values of residual signals calculated in the subtraction unit 102 between pixels. The coefficient λ is a real number that is larger than a pre-configured zero. The coding parameter determination unit 110 selects a set of coding parameters by which the calculated cost value is minimized. With this configuration, the entropy coding unit 104 outputs the selected set of coding parameters as the coding stream Te to the outside, and does not output sets of coding parameters that are not selected. The coding parameter determination unit 110 stores the determined coding parameters in the prediction parameter memory 108.

The prediction parameter coding unit 111 derives a format for coding from parameters input from the coding parameter determination unit 110, and outputs the format to the entropy coding unit 104. A derivation of a format for coding is, for example, to derive a difference vector from a motion vector and a prediction vector. The prediction parameter coding unit 111 derives parameters necessary to generate a prediction image from parameters input from the coding parameter determination unit 110, and outputs the parameters to the prediction image generation unit 101. For example, parameters necessary to generate a prediction image are a motion vector of a subblock unit.

The inter-prediction parameter coding unit 112 derives inter-prediction parameters such as a difference vector, based on prediction parameters input from the coding parameter determination unit 110. The inter-prediction parameter coding unit 112 includes a partly identical configuration to a configuration by which the inter-prediction parameter decoding unit 303 (see FIG. 5 and the like) derives inter-prediction parameters, as a configuration to derive parameters necessary for generation of a prediction image output to the prediction image generation unit 101. A configuration of the inter-prediction parameter coding unit 112 will be described below.

The intra-prediction parameter coding unit 113 derives a format for coding (for example, MPM_idx and rem_intra_luma_pred_mode) from the intra-prediction mode IntraPredMode input from the coding parameter determination unit 110.

### Configuration of Main Portion of Image Decoding Device

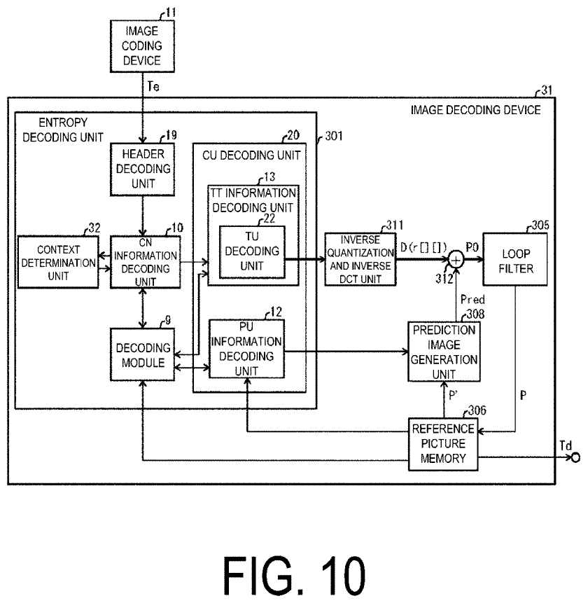

FIG. 10 is a block diagram illustrating a configuration of a main portion of an image decoding device according to the present embodiment. In FIG. 10, some members included in the block diagram illustrated in FIG. 5 are omitted in the drawing for the sake of simplicity. For convenience of explanation, members having the same functions as those of the members illustrated in FIG. 5 are assigned the same reference signs, and descriptions thereof will be omitted.

As illustrated in FIG. 10, an image decoding device 31 includes an entropy decoding unit 301, a prediction image generation unit 308, an inverse quantization and inverse DCT converter 311, a reference picture memory 306, an addition unit 312, and a loop filter 305. The entropy decoding unit 301 includes a decoding module 9, a CN information decoding unit 10 (split information decoding unit), a header decoding unit 19, a CU decoding unit 20, and a context determination unit 32. The CU decoding unit 20 further includes a PU information decoding unit 12 and a TT information decoding unit 13 (split information decoding unit, splitting unit), and the TT information decoding unit 13 further includes a TU decoding unit 22.

### Decoding Module

The general operation of each module will be described below. The decoding module 9 performs decoding processing to decode a syntax value from the binary. More specifically, the decoding module 9 decodes a syntax value coded by a variable-length coding scheme such as CABAC or a fixed-length coding scheme based on coding data and syntax types supplied from a supply source, and returns the decoded syntax value to the supply source.

In the examples given below, the supply sources of the coding data and the syntax types are the CN information decoding unit 10 and the CU decoding unit 20 (the PU information decoding unit 12 and the TT information decoding unit 13).

### Header Decoding Unit

The header decoding unit 19 decodes a video parameter set (VPS), an SPS, a PPS, and a slice header of the coding data input from the image coding device 11.

### CN Information Decoding Unit

The CN information decoding unit 10 uses the decoding module 9 to perform decoding processing of the coding tree unit (CTU) and the coding node (CN) with respect to the coding data input from the image coding device 11. Specifically, the CN information decoding unit 10 decodes CTU information and CN information from the coding data in accordance with the following procedure.

First, the CN information decoding unit 10 (split information decoding unit) decodes a tree unit header CTUH from the CTU information included in the CTU using the decoding module 9. Next, the CN information decoding unit 10 decodes a QT split flag from the CN information included in the CN in accordance with a context (to be explained later) of the QT split flag (split information) indicating whether or not to perform a QT split on the target CN. Then, the CN information decoding unit 10 recursively splits and decodes the target CN until the QT split flag does not signal an additional split any more. Finally, a tree unit footer CTUF is decoded from the CTU information.

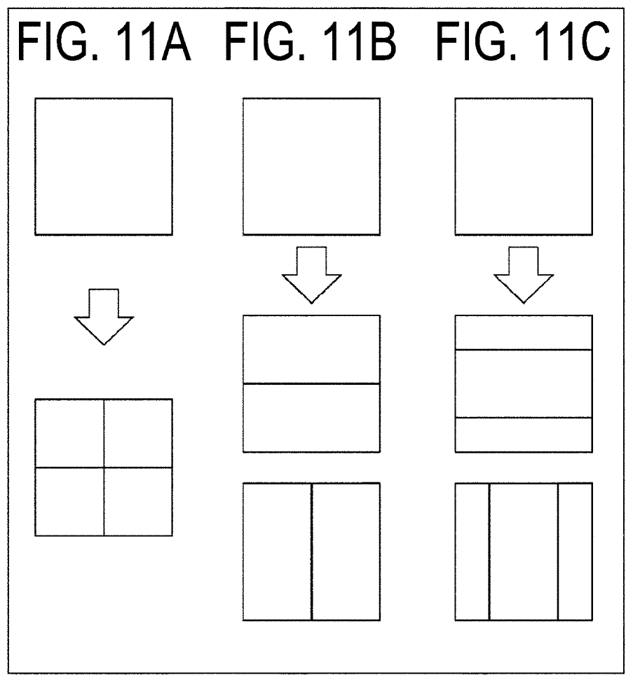

Although, in the present embodiment, an example in which CN information to be decoded is a QT split flag (qt_split_flag) is described, CN information to be decoded may be a BT split flag (bt_split_flag) indicating whether or not to perform a BT (binary tree) split on the target CN, or a TT split flag (tt_split_flag) indicating whether or not to perform a TT (triple tree) split on the target CN. FIGS. 11A to 11C are diagrams illustrating a QT split, BT split, and TT split, respectively. In each of the drawings, a block indicated by an arrow is a block after the split. As illustrated in FIG. 11A, the QT split is a split in which a block is split into four pieces. As illustrated in FIG. 11B, the BT split is a split in which a block is split into two pieces. As illustrated in FIG. 11C, the TT split is a split in which a block is split into three pieces.

Although the image decoding device 31 according to the present embodiment splits CNs, it may split blocks of CUs, PUs, TUs, or the like by a similar method. In that case, the above-mentioned target CN may be a target CU, a target PU, a target TU, or the like.

The tree unit header CTUH and the tree unit footer CTUF include coding parameters referred to by the image decoding device 31 to determine a decoding method for the target coding tree unit. The CN information may include, in addition to the QT split flag, a BT direction flag (BT split mode) to be explained later, and parameters applied to the target CN and the coding node at a lower level.

### Context Determination Unit

The context determination unit 32 acquires split-related information of a target CN and split-related information of a neighboring CN. The split-related information of a CN is information related to a split situation of the CN, and is information including, for example, a partition number, a depth or vertical and horizontal depths, or a size of the CN.

Next, the context determination unit 32 compares the acquired split-related information of the target CN with that of the neighboring CN.

Further, the context determination unit 32 determines a context in accordance with the comparison result. The context determined by the context determination unit 32 is output to the CN information decoding unit 10.

The context in the present specification indicates a context index in CABAC. In CABAC, binarization processing is performed on various types of syntax representing conversion coefficients, and arithmetic coding of binary data obtained by the binarization processing is performed. Here, as the above-mentioned various types of syntax, for example, the following can be cited: the flag qt_split_flag indicating whether or not to perform the QT split; a flag indicating whether or not the conversion coefficient is 0, that is, a flag significant_coeff_flag (also referred to as a conversion coefficient presence/absence flag) indicating presence/absence of a non-zero conversion coefficient; and syntax of last_significant_coeff_x and last_significant_coeff_y indicating a position of the last non-zero conversion coefficient in the order of processing.

Additionally, in CABAC, in a case that one symbol (one bit of binary data, also referred to as Bin) is coded, a context index corresponding to the processing target symbol is referred to, and arithmetic coding is performed in accordance with a generation probability specified by the context index. The generation probability is updated every time a symbol is coded.

In the present specification, a context corresponding to qt_split_flag as the QT split flag is indicated by ctxIdxQT (or ctxIdxSplit). A context corresponding to bt_split_flag as the BT split flag is indicated by ctxIdxBT (or ctxIdxSplit). A context corresponding to tt_split_flag as the TT split flag is indicated by ctxIdxTT (or ctxIdxSplit). A context corresponding to bt_dir_flag or tt_dir_flag as the BT split direction flag or the TT split direction flag is indicated by ctxIdxDir. In other words, ctxIdxDir is a context indicating whether a horizontal split or a vertical split is taken as the split direction.

Further, in the present specification, in a case that the BT split and the TT split are not distinguished and a split including both of them is taken as a PT split, a context corresponding to pt_split_flag as a PT split flag is indicated by ctxIdxPT (or ctxIdxSplit). A context corresponding to pt_dir_flag as a PT split direction flag is indicated by ctxIdxDir. A context corresponding to pt_pat_flag as a PT split pattern flag is indicated by ctxIdxPat.

### CU Decoding Unit

The CU decoding unit 20 is constituted of the PU information decoding unit 12 and the TT information decoding unit 13, and decodes PUI information and TTI information of a coding node CN of the lowest level (in other words, a CU).

### PU Information Decoding Unit

The PU Information decoding unit 12 decodes, using the decoding module 9, PU information of each PU (the merge flag (merge_flag), merge index (merge_idx), prediction vector index (mvp_idx), reference image index (ref_idx), inter-prediction indicator (inter_pred_flag), difference vector (mvd), and the like).

### TT Information Decoding Unit

The TT information decoding unit 13 decodes, using the decoding module 9, TT information of the transform tree TT (a TU split flag SP_TU (split_transform_flag), a TU residual flag CBP_TU (cbf_cb, cbf_cr, cbf_luma) and the like, and a TU).

The TT information decoding unit 13 includes the TU decoding unit 22. The TU decoding unit 22 decodes QP update information (quantization correction value) in a case that the TU includes a residual. The QP update information is a value indicating a difference value from a quantization parameter prediction value qPpred, which is a prediction value of a quantization parameter QP. The TU decoding unit 22 decodes a quantization prediction residual (residual_coding).

### Context Determination Method

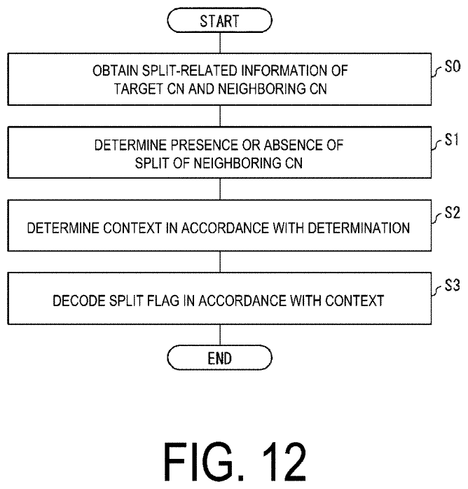

A method for determining a context by the image decoding device 31 according to the present embodiment will be described in detail with reference to FIG. 12. FIG. 12 is a flowchart explaining an example of a context determination method performed by the image decoding device 31 according to the present embodiment.

The context determination unit 32 acquires, from the CN information decoding unit 10, split-related information of the target CN (target block) which the CN information decoding unit 10 has not split yet, and split-related information of a neighboring CN (neighboring block) which is adjacent to the target CN and has already been split and decoded by the CN information decoding unit 10. (step S0). Although, in the present specification, an example in which a target CN is used as a target block and a neighboring CN is used as a neighboring block is given, the target block and the neighboring block may be a CU, PU, or TU. In a case where the target block and the neighboring block are a CU, PU, or TU, the context determination method according to the present embodiment can be similarly performed, and it is possible to determine a context indicating a probability of decoding a QT split flag indicating whether or not to split the target CU, the target PU, or the target TU.

The context determination unit 32 specifies a split situation with reference to the acquired target CN and neighboring CN, so as to determine whether or not there exists a split line of the neighboring CN adjacent to each side (e.g., an upper side or a left side) of the target CN (step S1). A specific method of step S1 will be described later.

The context determination unit 32 determines the context in accordance with the determined split situation (step S2). A specific method of step S2 will be described later.

The CN information decoding unit 10 decodes a QT split flag indicating whether or not to perform a QT split on the target CN from the CN information included in the CN, in accordance with the context determined by the context determination unit 32 (step S3).

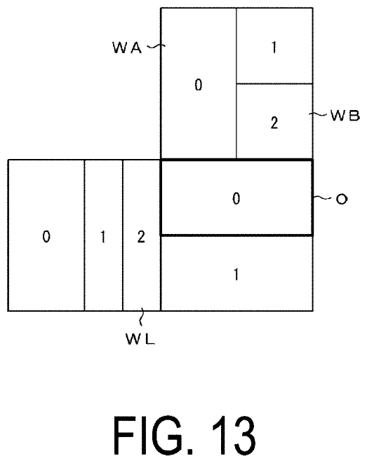

A specific method of the context determination method of the present embodiment will be described below. FIG. 13 is a diagram for explaining step S1 of the context determination method of the present embodiment, where a target block O, a neighboring block WL, a neighboring block WA, and a neighboring block WB are illustrated. As illustrated in FIG. 13, the target block O is adjacent to the neighboring block WL on the left side. In addition, the target block O is adjacent to the neighboring block WA and the neighboring block WB on the upper side. A number in each block in FIG. 13 represents a partition number.

In the following description, the context determination unit 32 derives a vertical-direction split flag splitVertically and a horizontal-direction split flag splitHorizontally; these may also be referred to as a horizontal split flag horSplit and a vertical split flag verSplit, respectively. In summary, the relationship of equivalent flags is as follows.

splitVertically=horSplit

splitHorizontally=verSplit

Furthermore, in a case that a vertical-direction split flag splitVertically is derived from the left neighboring block, splitVertically is also referred to as splitLeft; in a case that a horizontal-direction split flag splitHorizontally is derived from the upper neighboring block, splitHorizontally is also referred to as splitAbove.

First, in step S1, the context determination unit 32 references the split-related information of the neighboring block WL acquired in step S0 to determine whether or not there exists a split line adjacent to an edge where the neighboring block WL is adjacent to the target block O (that is, the left side of the target block O). The context determination unit 32 outputs the result of determining the presence/absence of a split line as a vertically split flag splitVertically (hereinafter, may also be referred to as splitLeft or a horizontal split flag horSplit). As illustrated in FIG. 13, because no split line is adjacent to the left side of the target block O, the context determination unit 32 sets a relation of splitVertically(=splitLeft=horSplit)=0, which indicates that there exists no split line.

Further, the context determination unit 32 references the split-related information of the neighboring block WA and the neighboring block WB acquired in step S0 to determine whether or not there exists a split line adjacent to an edge where a joined block of the neighboring block WA and neighboring block WB is adjacent to the target block O (that is, the upper side of the target block O). Then, the context determination unit 32 outputs the result of determining the presence/absence of a split line as a horizontal split flag splitHorizontally (hereinafter, may also be referred to as splitAbove or a vertical split flag verSplit). As illustrated in FIG. 13, because there is a split line adjacent to the upper side of the target block O, the context determination unit 32 sets a relation of splitHorizontally(=splitAbove=verSplit)=1, which indicates that there exists a split line.

Next, in step S2, the context determination unit 32 references the set splitVertically and splitHorizontally to derive a context ctxIdxSplit of whether or not to split the target block by the following equation, for example.

ctxIdxSplit=splitVertically+splitHorizontally(=splitLeft+splitAbove=horSplit+verSplit)

In the case of the example of the neighboring blocks illustrated in FIG. 13, since a relation of splitVertically=0, and a relation of splitHorizontally=1 are satisfied, the context determination unit 32 outputs a relation of ctxIdxSplit=1. The generation probability specified by a probability state index included in context variables indicated by the context is set and updated to be high depending on the presence of split lines. In other words, by switching the contexts depending on whether or not there exists a split line of the neighboring block, the CN information decoding unit 10 can reduce the code amounts by decoding a split flag indicating “the presence of a split” in the target block O in the case that there is a split line in the neighboring block. The reason for the above setting is such that, in the case where the neighboring block WA or WB is split, there is a high probability that the target block O will be split as well.

In the following specific examples, specific examples of steps S1 and S2 in the context determination method described above will be described in detail with reference to the drawings.

### First Specific Example

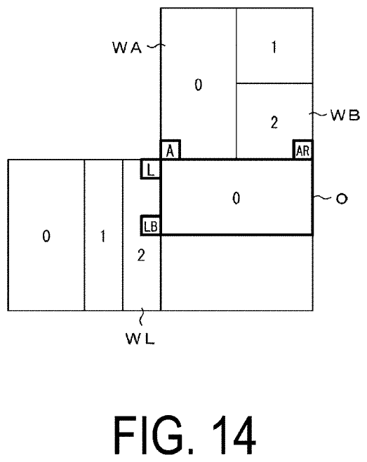

FIG. 14 is a diagram illustrating step S1 in the context determination method according to the present specific example, and illustrating the target block O, the neighboring block WL, the neighboring block WA, and the neighboring block WB. As illustrated in FIG. 14, the target block O is adjacent to the neighboring block WL on the left side. In addition, the target block O is adjacent to the neighboring block WA and the neighboring block WB on the upper side.

Note that, as illustrated in FIG. 14, the upper-left coordinates of the target block O are denoted by (xP, yP), point coordinates directly adjacent to the left of the upper-left coordinates of the target block O are defined as a point L (xP−1, yP), and point coordinates directly adjacent to the left of the lower-left coordinates of the target block O are denoted as a point LB (xP−1, yP+H−1). The point coordinates located immediately above the upper left coordinates of the target block O in an adjacent manner are defined as a point A (xP, yP−1), and point coordinates located immediately above the upper right coordinates of the target block O in an adjacent manner are defined as a point AR (xP+W−1, yP−1). Note that W is a width of the target block O in an X-axis direction, and H is a height of the target block O in a Y-axis direction. A number in each block in FIG. 14 represents a partition number.

First, in step S1, the context determination unit 32 refers to the split-related information for the neighboring block WL obtained in step S0 to determine whether or not a partition number partIDL of the block including the point L is different from a partition number partIDLB of the block including the point LB. The equation for the determination will be provided below.

splitVertically(=splitLeft=horSplit)=partIDL!=partIDLB?1:0

In a case that the partition number of the block including the point L and the partition number of the block including the point LB are different from each other, this means that each of the point L and the point LB is included in a different block, and thus the context determination unit 32 determines that a split line adjacent to the left side of the target block O exists. On the other hand, in a case that the partition number of the block including the point L and the partition number of the block including the point LB are identical, the point L and the point LB are included in an identical block, and thus the context determination unit 32 determines that no split line adjacent to the left side of the target block O exists.

The context determination unit 32 outputs, as splitVertically(=splitLeft=horSplit) described above, a result of the determination of whether or not the partition number partID of the block including the point L and the partition number partIDLB of the block including the point LB are different.

In one example, as illustrated in FIG. 14, the point L and the point LB are included in the identical neighboring block WL, so the context determination unit 32 configures splitVertically=0 indicating that no split line is present.

Similarly, the context determination unit 32 refers to the split-related information for the neighboring block WA and the neighboring block WB obtained in step S0 to determine whether or not a partition number partIDA of the block including the point A is different from a partition number partIDAR of the block including the point AR. The equation for the determination will be provided below.

splitHorizontally(=splitAbove=verSplit)=partIDA!=partIDAR?1:0

Then, the context determination unit 32 outputs a result of the determination as splitHorizontally(=splitAbove=verSplit). As illustrated in FIG. 14, the points A and AR are included in the different neighboring blocks WA and WB, respectively, so the context determination unit 32 configures splitHorizontally=1 indicating that a split line is present.

Next, in step S2, the context determination unit 32 refers to the configured splitVertically and splitHorizontally to determine the context ctxIdxSplit=splitVertically+splitHorizontally. In the case of the present specific example, splitVertically=0 and splitHorizontally=1 are satisfied, and thus the context determination unit 32 outputs ctxIdxSplit=1.

### Second Specific Example

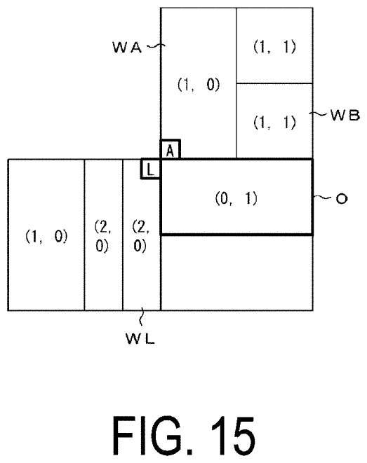

FIG. 15 is a diagram illustrating step S1 of the context determination method according to the present specific example, and illustrates the target block O, the neighboring block WL, and the neighboring block WA. As illustrated in FIG. 15, the target block O is adjacent to the neighboring block WL on a left side. In addition, the target block O is adjacent to the neighboring block WA on an upper side. Also, as illustrated in FIG. 15, the neighboring block WL includes a point L (xPb−1, yP) on the left side of the target block O, and the neighboring block WA includes a point A (xPb, yPb−1) on the top side of the target block O. Note that, as for (n, m) in each block in FIG. 15, n indicates a horizontal depth, and m indicates a vertical depth (n and m are integers). Note that the horizontal depth indicates the number of times that a block is split into two horizontally aligned blocks (split hierarchy). Additionally, the vertical depth indicates the number of times that a block is split into two vertically aligned blocks (split hierarchy). For example, each of the horizontal depth and the vertical depth of a coding tree block CTB is zero (depthHor=0) (depthVer=0) before the splitting. In the QT split, each of the horizontal depth and vertical depth is incremented by one (depthHor=depthHor+1) (depthVer=depthVer+1) for each split.

In the BT split, one of the horizontal depth and the vertical depth is incremented by one for each split. In a case that a block is horizontally split into an upper block and a lower block (bt_split_flag=1 (BT split flag), bt_dir_flag=0 (BT split direction flag)), the vertical depth is incremented by one (depthVer=depthVer+1). In a case that a block is vertically split into a left block and a right block (bt_split_flag=1 (BT split flag), bt_dir_flag=1 (BT split direction flag)), the horizontal depth is incremented by one (depthHor=depthHor+1).

In the TT split, in a case that the central block of the TT split blocks (the partition number is 1 (partIdx=1)) is horizontally split into an upper block and a lower block (pt_split_flag=1, pt_dir_flag=0, pt_pat_flag=1), the vertical depth is incremented by one (depthVer=depthVer+1). In a case that the central block (partIdx=1) of the TT split blocks is vertically split into a left block and a right block (pt_split_flag=1, pt_dir_flag=1, pt_pat_flag=1), the horizontal depth is incremented by one (depthHor=depthHor+1).

In addition, in a case that blocks other than the central block of the TT split blocks (the partition number is zero or two (partIdx=0 or 2)) are horizontally split into upper blocks and lower blocks (pt_split_flag=1, pt_dir_flag=0, pt_pat_flag=0 or 2), the vertical depth is incremented by two (depthVer=depthVer+2). In a case that blocks other than the central block of the TT split blocks (partIdx=0 or 2) are vertically split into left blocks and right blocks (pt_split_flag=1, pt_dir_flag=1, pt_pat_flag=1), the horizontal depth is incremented by two (depthHor=depthHor+2).

First, in step S1, the context determination unit 32 refers to the split-related information for the neighboring block WL and the target block O, compares a vertical depth depthVerLeft of the point L (vertical depth depthVerLeft of the neighboring block WL including the point L) with a vertical depth depthVertCurr of the target block O, and determines whether or not the vertical depth depthVerLeft of the neighboring block WL is larger than the vertical depth depthVertCurr of the target block O. The equation for the determination will be provided below.

splitVertically(=splitLeft=horSplit)=depthVerLeft>depthVertCurr?1:0

In a case that the vertical depth of the neighboring block WL adjacent to the left of the target block O is larger than the vertical depth of the target block O, the neighboring block WL is a block formed by being horizontally split a larger number of times than the target block O, so the context determination unit 32 determines that a split line adjacent to the left side of the target block O exists. On the other hand, in a case that the vertical depth of the neighboring block WL is smaller than the vertical depth of the target block O, the target block O is a block formed by being horizontally split a larger number of times than the neighboring block WL, so the context determination unit 32 determines that no split line adjacent to the left side of the target block O exists. Note that in a case that the vertical depth of the neighboring block WL and the vertical depth of the target block O are equal, the context determination unit 32 determines that no split line adjacent to the left side of the target block O exists.

Then, the context determination unit 32 outputs, as splitVertically, a result of the determination of whether or not the vertical depth of the neighboring block WL is larger than the vertical depth of the target block O. As illustrated in FIG. 15, because the vertical depth of the neighboring block WL is smaller than the vertical depth of the target block O, the context determination unit 32 configures splitVertically=0 indicating that no split line is present.

Moreover, the context determination unit 32 refers to the split-related information for the neighboring block WA and the target block O, compares the horizontal depth depthHorUpper of the point A (horizontal depth depthHorUpper of the neighboring block WA including the point A) with the horizontal depth depthHorCurr of the target block O, and determines whether or not the horizontal depth depthHorUpper of the neighboring block WA is larger than the horizontal depth depthHorCurr of the target block O. The equation for the determination will be provided below.

splitHorizontally(=splitAbove=verSplit)=depthHorUpper>depthHorCurr?1:0

In a case that the horizontal depth of the neighboring block WA located immediately above the target block O in an adjacent manner is larger than the horizontal depth of the target block O, the neighboring block WA is a block formed by being vertically split a larger number of times than the target block O, so the context determination unit 32 determines that a split line adjacent to the upper side of the target block O exists. On the other hand, in a case that the horizontal depth of the neighboring block WA is smaller than the horizontal depth of the target block O, the target block O is a block formed by being vertically split a larger number of times than the neighboring block WA, so the context determination unit 32 determines that no split line adjacent to the upper side of the target block O exists. Note that in a case that the horizontal depth of the neighboring block WA and the horizontal depth of the target block O are equal, the context determination unit 32 determines that no split line adjacent to the upper side of the target block O exists.

The context determination unit 32 outputs, as splitHorizontally, a result of the determination of whether or not the horizontal depth of the neighboring block WA is larger than the horizontal depth of the target block O. As illustrated in FIG. 15, the horizontal depth of the neighboring block WA is larger than the horizontal depth of the target block O, and thus the context determination unit 32 outputs splitHorizontally=1 indicating that a split line is present.

Next, in step S2, the context determination unit 32 refers to the configured splitVertically and splitHorizontally to determine the context ctxIdxSplit=splitVertically+splitHorizontally. In the case of the present specific example, splitVertically=0 and splitHorizontally=1 are satisfied, and thus the context determination unit 32 outputs ctxIdxSplit=1.

### Third Specific Example

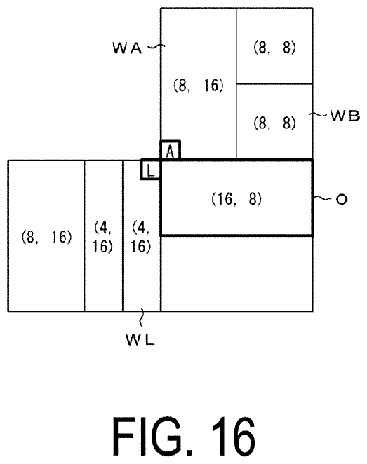

FIG. 16 is a diagram illustrating step S1 of the context determination method according to the present specific example, and illustrates the target block O, the neighboring block WL, and the neighboring block WA. As illustrated in FIG. 16, the target block O is adjacent to the neighboring block WL on the left side. In addition, the target block O is adjacent to the neighboring block WA on the upper side. Also, as illustrated in FIG. 16, the neighboring block WL includes the point L (xPb−1, yP) on the left side of the target block O, and the neighboring block WA includes the point A (xPb, yPb−1) on the upper side of the target block O. Note that, as for (n, m) in each block in FIG. 16, n indicates a width of each block in a horizontal direction and m indicates a height in a vertical direction (n and m are integers).

First, in step S1, the context determination unit 32 refers to the split-related information for the target block O and the neighboring block WL, compares a height heightCurr of the target block O with a height heightLeft of the neighboring block WL including the point L, and determines whether or not the height heightCurr of the target block O is larger than the height heightLeft of the neighboring block WL. The equation for the determination will be provided below.

splitVertically(=splitLeft=horSplit)=heightLeft<heightCurr?1:0

In a case that the height of the target block O is larger than the height of the neighboring block WL, the neighboring block WL is a block formed by being horizontally split a larger number of times than the target block O, so the context determination unit 32 determines that a split line adjacent to the left side of the target block O exists. On the other hand, in a case that the height of the target block O is smaller than the height of the neighboring block WL, the target block O is a block formed by being horizontally split a larger number of times than the neighboring block WL, so the context determination unit 32 determines that no split line adjacent to the left side of the target block O exists. Note that in a case that the height of the target block O and the height of the neighboring block WL are equal, the context determination unit 32 determines that no split line adjacent to the left side of the target block O exists in a horizontal direction.

The context determination unit 32 outputs, as splitVertically, a result of the determination of whether or not the height of the target block O is larger than the height of the neighboring block WL. As illustrated in FIG. 16, since the height of the target block O is smaller than the height of the neighboring block WL, the context determination unit 32 configures splitVertically=0 indicating that no split line exists.

The context determination unit 32 refers to the split-related information of the target block O and the neighboring block WA, compares a width widthCurr of the target block O with a width widthAbove of the neighboring block WA including the neighboring block A and determines whether or not the width widthCurr of the target block O is larger than the width widthAbove of the neighboring block WA. The equation for the determination will be provided below.

splitHorizontally(=splitAbove=verSplit)=widthAbove<widthCurr?1:0

In a case that the width of the target block O is larger than the width of the neighboring block WA, the neighboring block WA is a block formed by being vertically split a larger number of times than the target block O, so the context determination unit 32 determines that a split line adjacent to the upper side of the target block O exists. On the other hand, in a case that the width of the target block O is smaller than the width of the neighboring block WA, the target block O is a block formed by being vertically split a larger number of times than the neighboring block WA, so the context determination unit 32 determines that no split line adjacent to the upper side of the target block O exists. Note that in a case that the width of the target block O and the width of the neighboring block WA are equal, the context determination unit 32 determines that no split line adjacent to the upper side of the target block O exists.

The context determination unit 32 outputs, as splitHorizontally, a result of whether or not the width of the target block O is larger than the width of the neighboring block WA. As illustrated in FIG. 16, the width of the target block O is larger than the width of the neighboring block WA, and thus the context determination unit 32 configures splitHorizontally=1 indicating that a split line is present.

Next, in step S2, the context determination unit 32 refers to the configured splitVertically and splitHorizontally to determine the context ctxIdxSplit=splitVertically+splitHorizontally(=splitLeft+splitUpper). In the case of the present specific example, splitVertically=0 and splitHorizontally=1 are satisfied, and thus the context determination unit 32 outputs ctxIdxSplit=1.

### Fourth Specific Example

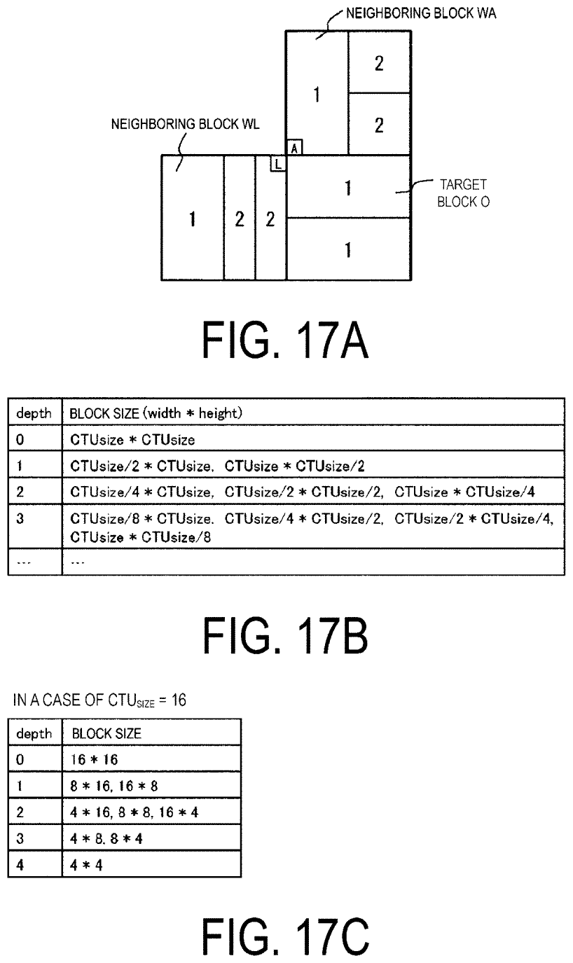

A specific method of the context determination method according to the present embodiment will be described below. FIGS. 17A to 17C are diagram illustrating the context determination method S1202 according to the present embodiment, and illustrates the target block O, the neighboring block WL, and the neighboring block WA. As illustrated in FIGS. 17A to 17C, the target block O is adjacent to the neighboring block WL on the left side. In addition, the target block O is adjacent to the neighboring block WA on the upper side. Also, as illustrated in FIGS. 17A to 17C, the neighboring block WL includes the point L (xPb−1, yP) on the left side of the target block O, and the neighboring block WA includes the point A (xPb, yPb−1) on the upper side of the target block O. Note that a number in each block in FIGS. 17A to 17C indicates the split-related information (depth). The depth indicates the number of times that a block is split into two blocks (split hierarchy) that are horizontally or vertically aligned. For example, the depth of the coding tree unit CTU before the splitting is zero (depth=0). In one QT split, a block is split once in each of the horizontal and vertical directions, so that the depth is incremented by two (depth=depth+2).

In one BT split, the depth is incremented by one (depth=depth+1) because a block is split once in the horizontal or vertical direction.

In one TT split, in a case that the central block of the TT split block is split once, the depth is incremented by one (depth=depth+1). Additionally, in a case that the blocks other than the central block are split once, the depth is incremented by two (depth=depth+2).

Note that, in the following description, the context determination unit 32 derives the split in the vertical direction splitVertically (split into an upper block and a lower block) and the split in the horizontal direction splitHorizontally (split into a left block and a right block), the split in the vertical direction splitVertically and the split in the horizontal direction splitHorizontally may be referred to as a horizontal split flag horSplit and a vertical split flag verSplit, respectively. The relations of the equivalent flags are as follows.

splitVertically=horSplit

splitHorizontally=verSplit

Also, in a case that the split in the vertical direction splitVertically is derived from the left neighboring block, splitVertically is also referred to as splitLeft, and in a case that the split in the horizontal direction splitHorizontally is derived from the upper neighboring block, splitHorizontally is also referred to as splitAbove.

First, in S1202, the context determination unit 32 refers to the split-related information of the neighboring block WL and the target block O obtained in S1201, compares a depth depthLeft of the neighboring block WL with the depth depthCurr of the target block O, and determines whether or not the depth depthLeft of the neighboring block WL is larger than the depth depthCurr of the target block O. The equation for the determination will be provided below.

splitLeft=depthLeft>depthCurr?1:0

In a case that the depth of the neighboring block WL is larger than the depth of the target block O, the context determination unit 32 configures splitLeft=1. On the other hand, in a case that the depth of the neighboring block WL is smaller than the depth of the target block O, the context determination unit 32 configures splitLeft=0. Note that in a case that the depth of the neighboring block WL and the depth of the target block O are equal, the context determination unit 32 configures splitLeft=0. In FIGS. 17A to 17C, because the depth of the neighboring block WL is larger than the depth of the target block O, the context determination unit 32 configures splitLeft=1.

The context determination unit 32 refers to the split-related information of the neighboring block WA and the target block O obtained in S1201, compares the depth depthAbove of the neighboring block WA with the depth depthCurr of the target block O, and determine whether or not the depth depthAbove of the neighboring block WA is larger than the depth depthCurr of the target block O. The equation for the determination will be provided below.

splitAbove=depthAbove>depthCurr?1:0

In a case that the depth of the neighboring block WA is larger than the depth of the target block O, the context determination unit 32 configures splitAbove=1. On the other hand, in a case that the depth of the neighboring block WA is smaller than the depth of the target block O, the context determination unit 32 configures splitAbove=0. Note that in a case that the depth of the neighboring block WA and the depth of the target block O are equal, the context determination unit 32 configures splitAbove=0. In FIGS. 17A to 17C, the depth of the neighboring block WA is identical to the depth of the target block O, and thus the context determination unit 32 configures splitAbove=0.

Next, in S1203, the context determination unit 32 refers to splitLeft and splitAbove that are the comparison results to derive the context ctxIdxSplit of whether or not to split the target block, for example, by the following equation.

ctxIdxSplit=splitLeft+splitAbove

In FIGS. 17A to 17C, the context determination unit 32 outputs ctxIdxSplit=1, because splitLeft=1 and splitAbove=0 are satisfied. Note that the split flag is configured and updated so that a probability that ctxIdxSplit=1 is satisfied becomes higher, in a case that the neighboring block is split more than the target block (the depth of the neighboring block is larger than the depth of the target block). In addition, in a case that the neighboring block is identical to the target block or is not split (the depth of the neighboring block is equal to or smaller than the depth of the target block), the split flag is configured and updated so that the probability that ctxIdxSplit=1 is satisfied becomes lower. The CN information decoding unit 10 can compare the depth of the neighboring block with the depth of the target block, and switch the context to reduce a code amount.

The reason for such a configuration is because in a case that the neighboring block WA or the neighboring block WL is finely split, a probability that the target block O is also finely split is high.

In the above, a method (hereinafter, referred to as a method 1) of deriving the context ctxIdxSplit that indicates the probability required to code or decode the split flag of the target block (qt_split_flag, bt_split_flag, pt_split_flag) by referring to the split-related information of the neighboring block (depth) has been described. The above method compares the depth of the target block with the depth of the neighboring block, and represents whether or not the depth of the neighboring block is larger than the depth of the target block by using 1 and 0, and thus processing is simple. However, there is a problem in that the accuracy of the context is not good because a difference between the number of times that the target block and the neighboring block are split (depth difference, degree of depth difference), and a difference between block sizes (degree of size difference) are not utilized. More specifically, in a case that the depth of the neighboring block is much larger than the depth of the target block (e.g., the depth difference is larger than one), the target block is more likely to be split than in a case that the depth of the neighboring block is slightly larger than the depth of the target block (e.g., the depth difference is one). Similarly, in a case that the depth of the neighboring block is smaller than the depth of the target block (e.g., the depth difference is −1), the target block is less likely to be split than in a case that the depth of the target block and the depth of the neighboring block are equal (e.g., the depth difference is zero). There are also similar properties in a case of considering the block sizes instead of the depths of the target block and the neighboring block. Furthermore, as the difference between the corresponding block sizes is larger, the difference between the depths tends to become larger, and conversely, in a case that such properties are not used, a problem occurs in which the context is not accurate.

Hereinafter, a method of solving the above-described problem by deriving the context ctxIdxSplit of the split flag with reference to the difference between the split-related information will be described.

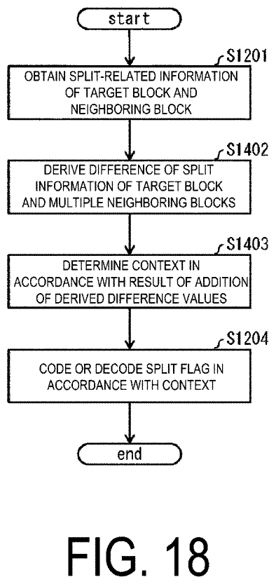

FIG. 18 is a flowchart illustrating an example of a context determination method performed by the image decoding device 31 or the image coding device 11. The difference from FIG. 12 is S1402 and S1403.

In the image decoding device 31, in S1201, the context determination unit 32 obtains, from the CN information decoding unit 10, the split-related information of the target block (target CN) and the split-related information of the neighboring block (neighboring CN) adjacent to the target CN. Note that, in the present specification, an example in which the target CN as the target block and the neighboring CN as the neighboring block are used is given, but the target block and the neighboring block may be CU, PU, or TU. In S1402, the context determination unit 32 derives difference values among the obtained split-related information of the target block and two neighboring blocks. In S1403, the context determination unit 32 determines the context from the result of adding the derived two difference values. In S1204, the CN information decoding unit 10 decodes the split flag indicating whether or not to split the target block from the CN information in accordance with the context determined by the context determination unit 32.

Additionally, in the image coding device 11, in S1201, the context determination unit 32 obtains the split-related information of the target block (target CN) and the split-related information of the neighboring block (neighboring CN) adjacent to the target CN. In S1402, the context determination unit 32 derives difference values among the obtained split-related information of the target block and two neighboring blocks. In S1403, the context determination unit 32 determines the context from the result of adding the derived two difference values. In S1204, the CN information coding unit 1042 codes the split flag indicating whether or not to split the target block in accordance with the context determined by the context determination unit 32.

In each of the following specific examples, specific examples of S1402 and S1403 in the context determination method described above will be described in detail with reference to the drawings.

### Fifth Specific Example Referring to Difference Between Split Hierarchy (Depths)

In the fifth specific example, an example will be described in which the depth is defined as the split-related information.

In S1402 in FIG. 18, a difference value diffDepth0 between the depth depthCurr of the target block and the depth depthAbove of the neighboring block WA, and a difference value diffDepth1 between the depth depthCurr of the target block and the depth depthLeft of the neighboring block WL are derived using the following equations.

diffDepth0=depthAbove−depthCurr

diffDepth1=depthLeft−depthCurr

In S1403 in FIG. 18, the context is derived from two difference values diffDepth0, diffDepth1 derived in S1402, by using the following equation.

ctxIdxSplit=diffDepth0+diffDepth1

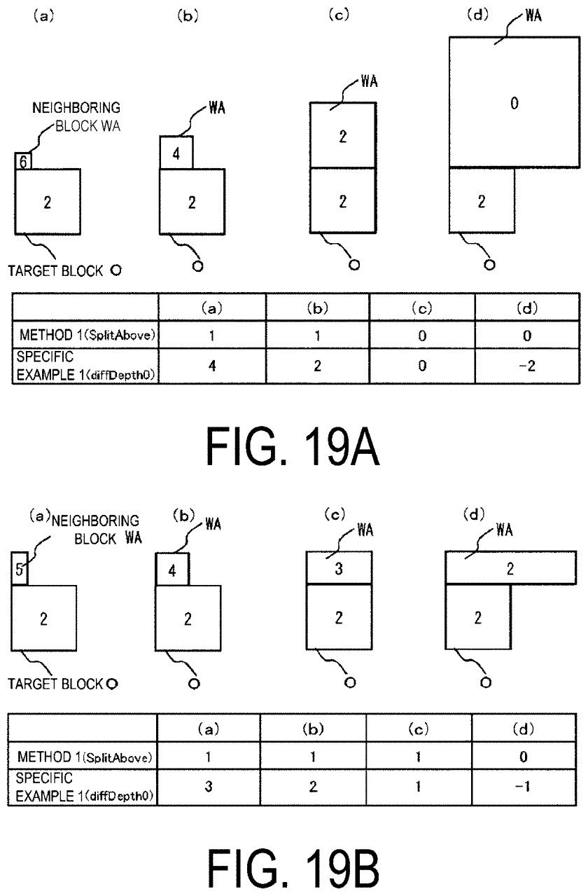

FIGS. 19A and 19B are examples illustrating the context ctxIdxSplit derived using the method 1 and the fifth specific example for the depths of the target block O and the neighboring block WA on the upper side of the target block O. A number in each block in FIGS. 19A and 19B represent the depth. Although the target block O and the neighboring block WA on the upper side of the target block O are described in FIGS. 19A and 19B, the same applies to the target block O and the neighboring block WL on the left side of the target block O, and descriptions thereof will be omitted. In FIG. 19A, in the method 1, in a case of (a) or (b) that the depth of the neighboring block WA is larger than the depth of the target block O, splitAbove=1 is satisfied, but in a case of (c) or (d) that it is not, splitAbove=0 is satisfied. In the fifth specific example, since a difference between the depth of the neighboring block WA and the depth of the target block O is derived, each diffDepth0 in (a), (b), (c), (d) is 4, 2, 0, −2, respectively. Accordingly, the fifth specific example can derive the context with higher accuracy. In FIG. 19B, in the method 1, in a case of (a), (b), or (c) that the depth of the neighboring block WA is larger than the depth of the target block O, splitAbove=1 is satisfied, but in a case of (d) that it is not, splitAbove=0 is satisfied. In the fifth specific example, since a difference between the depth of the neighboring block WA and the depth of the target block O is derived, each diffDepth0 in (a), (b), (c), (d) is 3, 2, 1, 0, respectively. Accordingly, the fifth specific example can derive the context with higher accuracy.

### Sixth Specific Example Referring to Difference Between Block Sizes (Width and Height)

In the sixth specific example, an example will be described in which a block size (width and height) is defined as the split-related information.

Here, the “block size” refers to the width of a block, or the height of a block, or both the width and the height of a block. Additionally, a product or a sum of the width and the height of a block may be used as the block size.

In S1402 in FIG. 18, a difference value diffSize0 between a logarithmic value log 2widthCurr of the width of the target block and a logarithmic value log 2widthAbove of the width of the neighboring block WA, and a difference value diffSize1 between a logarithmic value log 2heightCurr of the height of the target block and a logarithmic value log 2heightLeft of the height of the neighboring block WL are derived using the following equations.

diffSize0=log 2widthCurr−log 2widthAbove

diffSize1=log 2heightCurr−log 2heightLeft

In S1403 in FIG. 18, the context is derived from two difference values diffSize0, diffSize1 derived in S1402, by using the following equation.

ctxIdxSplit=diffSize0+diffSize1

### Seventh Specific Example Referring to Difference of Depth and Block Size (Width and Height)

In the seventh specific example, an example will be described in which the depth in the fifth specific example and the block size (width and height) in the sixth specific example are used as the split-related information.

In S1402 in FIG. 18, the difference values diffDepth0, diffDepth1, diffSize0, and diffSize1 are derived by the same method as those of the fifth specific example and the sixth specific example, and a difference of the depths and a difference of the block sizes are derived using the following equations.

diffDepth=diffDepth0+diffDepth1

diffSize=diffSize0+diffSize1

In S1403 in FIG. 18, from the two difference values diffDepth, diffSize derived in S1402, the context is derived as follows.

ctxIdxSplit=diffDepth+diffSize

Further, the context may be derived as will be described below.

ctxIdxSplit=(diffDepth+diffSize)>>1

Additionally, another example will be described in which the depth in the fifth specific example and the block size (width and height) in the sixth specific example are used as the split-related information.

As illustrated in FIG. 17B, since the depth can be expressed using the block size (width and height), in a case that the depth described above is expressed as the size, diffDepth0=(log 2widthCurr+log 2heightCurr)−(log 2widthAbove+log 2heightAbove), and diffDepth1=(log 2widthCurr+log 2heightCurr)−(log 2widthLeft+log 2heightLeft) are satisfied. Accordingly, the context is derived from diffTmp=3*log 2widthCurr+3*log 2heightCurr−2*log 2widthAbove−log 2heightAbove−log 2widthLeft−2*log 2heightLeft, and ctxIdxSplit=diffTmp. Otherwise, the context may be derived from diffTmp=(3*log 2widthCurr+3*log 2heightCurr−2*log 2widthAbove−log 2heightAbove−log 2widthLeft−2*log 2heightLeft)>>1, and ctxIdxSplit=diffTmp.

### Generalization of Fifth to Seventh Specific Examples

Finally, in a case of considering the width and the height of the neighboring block, “1) the logarithmic value log 2heightLeft of the height of the left neighboring block related to whether or not a split line exists on the left side of the target block, and the logarithmic value log 2widthAbove of the width of the upper neighboring block related to whether or not a split line exists on the upper side of the target block” are important for the derivation of the context, but “2) the logarithmic value log 2widthLeft of the width of the left neighboring block and the logarithmic value log 2heightAbove of the height of the upper neighboring block” also contribute to the derivation of the context. Accordingly, in a case that the difference values of the split-related information are added to derive the context, the difference values may be weighted with reference to the importance. At this time, in a case that 1) log 2heightLeft and log 2widthAbove having high importance are referred to as W1, and 2) log 2widthLeft and log 2heightAbove having low importance are referred to as W2, it is appropriate to configure highly important W1 so that W1>=W2 is satisfied. In this case, the addition of the split-related information is represented by the following equation.

diffTmp=((W1+W2)*log 2widthCurr+(W1+W2)*log 2heightCurr−W1*log 2widthAbove−W2*log 2heightAbove−W2*log 2widthLeft−W1*log 2heightLeft)

In the example described above, W1=1, and W2=1 correspond to the fifth specific example, W1=1, and W2=0 correspond to the sixth specific example, and W1=2, and W2=1 correspond to the seventh specific example. In addition, a configuration such as W1=3, and W2=1 is also possible.

### Eighth Specific Example Referring to at Least Three Neighboring Blocks

In the fifth to seventh specific examples, the context of the split flag was derived by referring to the split-related information of the target block and the two neighboring blocks. In the eighth specific example, an example will be described in which the context of the split flag is derived with reference to the split-related information of at least three neighboring blocks. Note that, in the following description, the split-related information will be the depth and this example will be described as an extension of the fifth specific example, but the disclosure is not limited thereto, the split-related information may be used as the block size, or both the depth and the block size, and a case that the sixth or third specific example is extended may be also applicable, so descriptions thereof will be omitted.

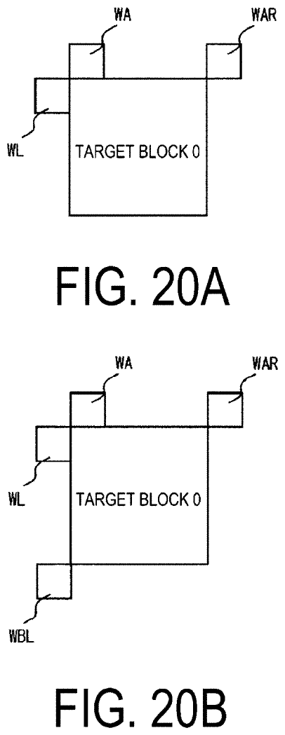

FIG. 20A is a diagram illustrating a positional relationship between the target block O and each of three neighboring blocks WA, WL, WAR.

In S1402 in FIG. 18, the difference values diffDepth0, diffDepth1, diffDepth2 among the depth depthCurr of the target block, the depth depthAbove of neighboring block WA, the depth depthLeft of the neighboring block WL, and a depth depthAboveRight of the neighboring block WAR are derived using the following equations.

diffDepth0=depthAbove−depthCurr

diffDepth1=depthLeft−depthCurr

diffDepth2=depthAboveRight−depthCurr

In S1403 in FIG. 18, the context is derived from the three difference values diffDepth0, diffDepth1, and diffDepth2 derived in S1402, by using the following equation.

ctxIdxSplit=diffDepth0+diffDepth1+diffDepth2

FIG. 20B is a diagram illustrating a positional relationship between the target block O and each of the four neighboring blocks WA, WL, WAR, WBL.

In S1402 in FIG. 18, the difference values diffDepth0, diffDepth1, diffDepth2, diffDepth3 among the depth depthCurr of the target block, the depth depthAbove of the neighboring block WA, the depth depthLeft of the neighboring block WL, the depth depthAboveRight of the neighboring block WAR, and a depth depthBottomLeft of the neighboring block WBL are derived using the following equations.

diffDepth0=depthAbove−depthCurr

diffDepth1=depthLeft−depthCurr

diffDepth2=depthAboveRight−depthCurr

diffDepth3=depthBottomLeft−depthCurr

In S1403 in FIG. 18, the context is derived from the four difference values diffDepth0, diffDepth1, diffDepth2, diffDepth3 derived in S1402, by using the following equation.

ctxIdxSplit=diffDepth0+diffDepth1+diffDepth2*diffDepth3

Additionally, in a case that the depths of the target block O and the four neighboring blocks WA, WL, WAR, WBL are used, the difference values may be derived using another calculation method. For example, in S1402 in FIG. 18, difference values are calculated using the following equations.

diffDepth0=depthAbove+DepthAboveRight−2*depthCurr

diffDepth1=depthLeft+depthBottomLeft−2*depthCurr

In S1403 in FIG. 18, the context is derived by using the following equation.

ctxIdxSplit=diffDepth0+diffDepth1

As still another example, the difference values are calculated by the following equations in S1402 in FIG. 18.

diffDepth0=((depthAbove+DepthAboveRight)>>1)−depthCurr

diffDepth1=((depthLeft+depthBottomLeft)>>1)−depthCurr

In S1403 in FIG. 18, the context is derived by using the following equation.

ctxIdxSplit=diffDepth0+diffDepth1

### Ninth Specific Example

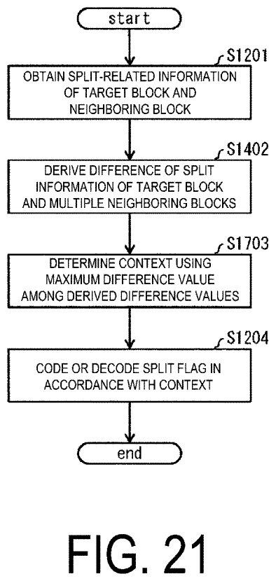

FIG. 21 is a flowchart illustrating another example of the context determination method performed by the image decoding device 31 or the image coding device 11. Differences between the flowcharts of FIG. 18 and FIG. 21 are S1403 and S1703. Since the other steps are the same, descriptions thereof will be omitted.

In S1403, the context determination unit 32 adds the two difference values calculated in S1402 to determine the context, but in S1703, determines the context by using a maximum difference value among the difference values calculated in S1402. This processing is expressed in the following equation.

ctxIdxSplit=max(diffDepth0, diffDepth1)

Since the context is determined using the maximum difference value in the ninth specific example, a situation with the larger number of split times (larger depth) is more likely to be selected.

### Availability Check

In the above description, the neighboring blocks of the target block O are assumed to be usable (available), but in practice, the neighboring block may not be present at an edge of an image or the like. In a case that no neighboring block is available, the difference value is 0. For example, in the fifth specific example, in S1402, the following procedure is performed.

diffDepth0=availableAbove? (depthAbove−depthCurr):0

diffDepth1=availableLeft? (depthLeft−depthCurr):0

ctxIdxSplit=diffDepth0+diffDepth1

Here, availableAbove and availableLeft indicate availability of neighboring blocks on the upper side of the target block and neighboring blocks on the left side of the target block, and in a case that a neighboring block exists, they are set to one, or in a case that no neighboring block exists, they are set to zero. Note that the check for the availability is not limited to the fifth specific example in which the difference value between the depths is derived, and the check can be applied to a case where the difference value between the sizes is derived, such as the sixth to ninth specific examples, or a case where both the difference value between the depths and the difference value between the sizes are used. For example, in the sixth specific example, the following procedure is performed.

diffSize0=availableAbove? log 2widthCurr−log 2widthAbove:0

diffSize1=availableLeft? log 2heightCurr−log 2heightLeft:0

ctxIdxSplit=diffSize0+diffSize1

### Clipping and Mapping

Each of the fifth to eighth specific examples is a technique for improving the accuracy of the context by finely configuring the context of the split flag by using the difference between the split-related information of the target block and the neighboring block. However, in a case that the difference value between the split-related information is simply added, a value range of the context is highly extensive in a case that the block size is large. For example, in a case that the CTU size is 128×128, the possible depth value range is 0 (corresponding to 128×128) to 11 (4×4), and the difference value range is −22 to 22. An increase in the value of the context leads to complexity of entropy coding and decoding processing, and leads to an increase in a memory amount necessary for a table, so is not preferable. In addition, since the context is normally assigned to an integer equal to or larger than zero, it is not preferable that a negative number occurs. Here, a technique for limiting the value range of the context by performing clipping and mapping, adding, multiplying, and shifting an offset, and the like in the process of deriving the context will be described.

As described in the flowchart in FIG. 18, the context determination unit 32, in a process flow, calculates the difference value between the split-related information in S1402, and derives the context from the result of adding the plurality of difference values in S1403. Note that, in the following description, the fifth specific example will be extended and described by using the depth as the split-related information, and since, by using the block size, or both the depth and the block size as the split-related information, the same method can be applied to a method in which the sixth or seventh specific example is extended, the description thereof will be omitted. Also, to the method using the maximum value described in FIG. 21, the clipping and mapping are similarly applicable and the description thereof will be omitted.

First, an example of performing clipping after adding, in S1403, the difference values calculated in S1402 will be described. The clipping is applied to a result of adding the difference value diffDepth0 between the depths of the target block O and the neighboring block WA and the difference value diffDepth1 between the depths of the target block O and the neighboring block WL, as indicated by the following equation.

diffTmp=clip3(0, THDmax, diffDepth0+diffDepth1+offsetD)

ctxIdxSplit=ctxTbl[diffTmp] (c1)

Here, ctxTbl is a table for deriving the context from the result of adding the difference values between the depths, and will be described later in detail. OffsetD is an offset for allowing a position (center) of a point where the difference value between the depths is zero to correspond to near a central element of the table ctxTbl. The clipping from 0 to THDmax is performed to reduce the number of necessary entries in the table, and THDmax+1 is the maximum number of the entries in the table.

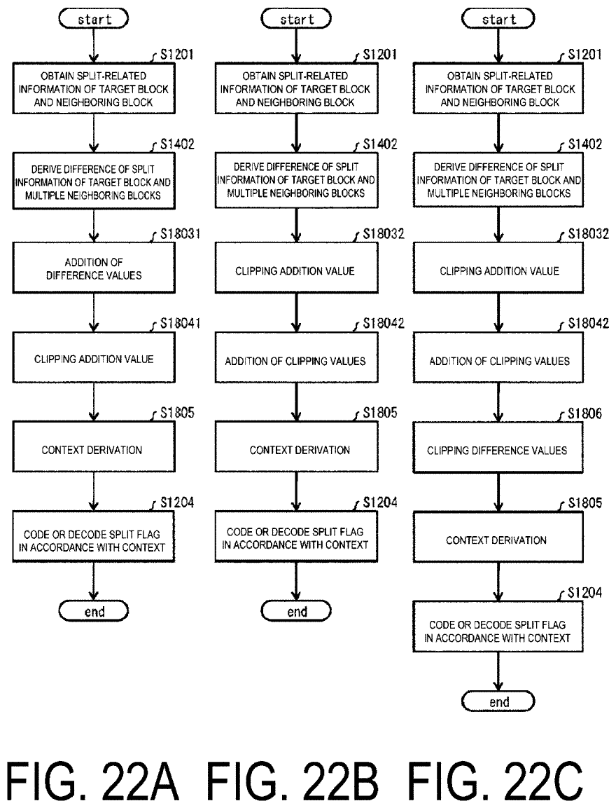

FIG. 22A is a flowchart for describing an operation of the clipping after adding the difference values. FIG. 22A is the same as FIG. 18 except that processing of S1403 in FIG. 18 has been changed to S18031, S18041, and S1805, so the description thereof will be omitted. In S18031, the context determination unit 32 adds the difference values derived in S1402. In S18041, the context determination unit 32 clips the addition value by using the method (c1). In S1805, the context determination unit 32 uses the clipping result to derive the context.

For example, it is assumed that in a case that ctxTbl[ ]={0, 1, 1, 2, 3}, offsetD=2, and THDmax=4 are satisfied, the above-described possible difference value from −22 to 22 can be changed in a range from −20 to 24 by the offset, then the limited value from 0 to 4 by the clipping can be input to the table to limit the context to four values in a range from 0 to 2. In addition, it is assumed that in a case that ctxTbl[ ]={0, 1, 2}, offsetD=1, and THDmax=2 are satisfied, the above-described possible difference value from −22 to 22 can be changed in a range from −21 to 23 by the offset, then the limited value from −1 to 1 by the clipping is input to the table to limit the context to three values in a range from 0 to 2. Additionally, it is assumed that in a case that ctxTbl[ ]={0, 1, 1, 2, 3, 3}, offsetD=2, and THDmax=5 are satisfied, the above-described possible difference value can be changed in a range from −20 to 24 by the offset, then the limited value from 0 to 5 by the clipping can be input to the table to limit the context to four values in a range from 0 to 3.

As another example, an example will be described in which results of clipping the difference values calculated in S1402 are added in S1403. The difference value diffDepth0 between the depths of the target block O and the neighboring block WA and the difference value diffDepth1 between the depths of the target block O and the neighboring block WL are clipped as indicated by the following equation.

diffDepth0=clip3(−offsetD, offsetD, depthAbove−depthCurr)

diffDepth1=clip3(−offsetD, offsetD, depthLeft−depthCurr)

diffTmp=diffDepth0+diffDepth1+(offsetD<<1)

ctxIdxSplit=ctxTbl[diffTmp] (c2)

FIG. 22B is a flowchart for describing an operation of adding the offset after clipping the difference values. FIG. 22B is the same as FIG. 18 except that the processing of S1403 in FIG. 18 has been changed to S18032, S18042, and S1805, and the description thereof is omitted. In S18032, the context determination unit 32 clips the difference values derived in S1402 by using the method (c2). In S18042, the context determination unit 32 adds the clipping values. In S1805, the context determination unit 32 uses the result of the addition to derive the context.

In this example, since the clipping is performed for each of a plurality of difference values between the depths, in a case that one difference value between the depths has become too large (or too small), there is an effect that a final result is not influenced too much by the difference value that has become too large (or too small).

As another example, an example will be described in which results of clipping the difference values calculated in S1402 are added in S1403 and are further clipped. The difference value diffDepth0 between the depths of the target block O and the neighboring block WA and the difference value diffDepth1 between the depths of the target block O and the neighboring block WL are clipped as indicated by the following equation.

diffDepth0=clip3(−offsetD1, offsetD1, depthAbove−depthCurr)

diffDepth1=clip3(−offsetD1, offsetD1, depthLeft−depthCurr)

diffTmp=clip3(0, THDmax, diffDepth0+diffDepth1+(offsetD1<<1))

ctxIdxSplit=ctxTbl[diffTmp] (c3)

FIG. 22C is a flowchart for describing an operation of clipping the difference values, then adding the clipped values, and further clipping the addition value. FIG. 22C is the same as FIG. 22B except that S1806 has been added between S18042 and S1805 in FIG. 22B, and the description thereof will be omitted. In S1806, the context determination unit 32 performs clipping by the method (c3).

In this example, since the clipping is performed after the addition, there is an effect that a final result is not influenced too much even in a case that the result of the addition has become too large (or too small).

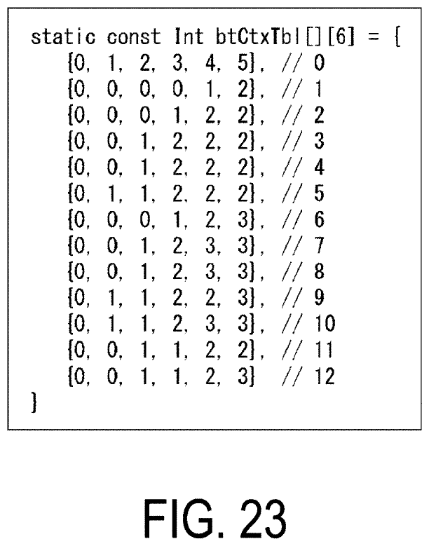

Note that, in the case of offsetD=2 and THDmax=5, a table for mapping the result of the addition or a maximum value to the context is illustrated in FIG. 23. These are combination examples of the results of the addition and the contexts that were effective in simulations. For example, CtxTbl[ ]={0, 0, 0, 1, 2, 2} that is mapped to three values of 0, 1, and 2, and CtxTbl[ ]={0, 0, 0, 1, 2, 3} that is mapped to four values of 0, 1, 2, and 3 are particularly suitable.

In the above, the table is used for mapping the result of adding the difference values to the context value, but other than mapping by using the table, a method may be used in which the context is derived by comparing the result of the addition with a predetermined threshold value as the following equations.

if (diffTmp<THD1) ctxIdx=0

else if (diffTmp<THD2) ctxIdx=1

else if (diffTmp<THD3) ctxIdx=2

else ctxIdx=3

Furthermore, as three examples described below, a method may be used in which a suitable range of the context is derived by varying a range of the addition value by using four arithmetic operations and shifting such as division, a shift operation, multiplication, or the like.

diffDepth0=depthAbove−depthCurr

diffDepth1=depthLeft−depthCurr

diffTmp=(diffDepth0+diffDepth1)/2 Example 1

diffTmp=(diffDepth0+diffDepth1)>>1 Example 2

diffTmp=(diffDepth0+diffDepth1)*3>>2 Example 3

Furthermore, the context may be derived from the addition value of the difference values by using a combination of the availability check, the clipping, the mapping, and the four arithmetic operations.

In the examples below, by using the availability check, the difference values diffDepth0, diffDepth1, diffSize0, diffSize1 between the depth and the sizes on the upper side and the left side which are positioned adjacently are derived and then clipped. Furthermore, from the addition value of the difference values, a difference value diffTmpD between the depths and a difference value diffTmpS between the sizes are derived, and an average value diffTmp thereof is used as an index to derive the context by the mapping using a table.

diffDepth0 = availableAbove ? (depthAbove − depthCurr) : 0
diffDepth1 = availableLeft ? (depthLeft − depthCurr) : 0
diffDepth0 = clip3(−offsetD1, offsetD1, diffDepth0)
diffDepth1 = clip3(−offsetD1, offsetD1, diffDepth1)
diffSize0 = availableAbove ? log2widthCurr − log2widthAbove : 0
diffSize1 = availableLeft ? log2heightCurr − log2heightLeft : 0
diffSize0 = clip3(−offsetD1, offsetD1, diffSize0)
diffSize1 = clip3(−offsetD1, offsetD1, diffSize1)
diffTmpD = clip3(0, THDmax, diffDepth0 + diffDepth1 + offsetD2)
diffTmpS = clip3(0, THSmax, diffSize0 + diffSize1 + offsetD2)
diffTmp = (diffTmpD + diffTmpS) >> 1
ctxIdxSplit = ctxTbl[diffTmp]

Here, for example, ctxTbl[ ]={0, 0, 1, 2, 3, 3}, offsetD1=1, offsetD2=2, THDmax=5, THSmax=5, and the like are suitable, but other values may be used.

Note that the above processing seems to be complicated due to the clipping, but eventually, the processing in which the clipping is removed will be described below. That is, as described above, in a case that the split-related information of the neighboring block can be used, the processing involves mapping the sum of differences between the splittable information (depth and size, here) to the context in an appropriate range of values by the table index.

diffDepth0 = availableAbove ? (depthAbove − depthCurr) : 0
diffDepth1 = availableLeft ? (depthLeft − depthCurr) : 0
diffSize0 = availableAbove ? log2widthCurr − log2widthAbove : 0
diffSize1 = availableLeft ? log2heightCurr − log2heightLeft : 0
diffTmpD = diffDepth0 + diffDepth1 + offsetD2
diffTmpS = diffSize0 + diffSize1 + offsetD2
diffTmp = (diffTmpD + diffTmpS) >> 1
ctxIdxSplit = ctxTbl[diffTmp]

### Image Coding Device

The configuration of the image decoding device 31 according to the present embodiment can also be applied to the image coding device 11. In such a case, the image coding device 11 includes a CN information coding unit (not illustrated) instead of the CN information decoding unit 10, and the context determination unit 32, and derives the context of the split flag (QT split flag, BT split flag, TT split flag, or the like) indicating whether to split the target block or not.

In the image coding device 11 having the above-described configuration, the context determination unit 32 obtains the split-related information of the target block that has not been split yet and the split-related information of the neighboring block that is adjacent to the target block and that has already been split. Next, the context determination unit 32 refers to the split-related information of the target block and the neighboring blocks to determine whether or not a split line exists in each neighboring block that is adjacent to each side of the target block by identifying a split situation of each neighboring block. Next, the context determination unit 32 determines the context in response to the determination. Next, the CN information coding unit codes the split flag indicating whether or not to split the target block depending on the context determined by the context determination unit 32.

### Summary of First Embodiment

As described above, the image decoding device 31 according to the present embodiment determines the context of the split information (the split flag) of the target block with reference to a split situation of at least one neighboring block adjacent to the target block, and uses the context to decode the split information of the target block. In addition, the image decoding device 31 according to the present embodiment determines whether or not the split line exists in the neighboring block by referring to the partition number, the horizontal depth and the vertical depth, or the size of the neighboring block to identify the split situation of the neighboring block, and determines the context by referring to the determination. With this, the image decoding device 31 can reflect the split-related information of the neighboring block and determine the more appropriate context, because of referring to the partition number, the horizontal depth and the vertical depth, or the size of the neighboring block. Accordingly, in the image decoding device, the code amount of the split information can be reduced.

The image coding device 11 and the image decoding device 31 according to the present embodiment determine the context of the split information (split flag) of the target block with reference to the split-related information of one or a plurality of neighboring blocks adjacent to the target block, and use the context to code or decode the split information of the target block. In addition, in the present embodiment, the image coding device 11 and the image decoding device 31 determine the split situation of the neighboring block by referring to the depth or the block size as the split-related information, and determine the context by referring to the determination. At this time, by using the difference values among the split-related information of the plurality of neighboring blocks, the split-related information of the neighboring block can be more accurately reflected, and the context can be accurately determined. Accordingly, the more appropriate context can be determined. In a case that a sign (±) of the difference value between the split-related information of the target block and the split-related information of the neighboring block is different, that is, in a case that there is a block with a larger depth and a block having an equal to or smaller depth than the target block, it is not always determined that the target block is likely to be split, and whether the target block is likely to be split or not can also be determined in accordance with the difference value. Accordingly, the code amount of the split information can be reduced in the image coding device and the image decoding device.

An image decoding device according to an aspect of the disclosure, the image decoding device being configured to decode a picture for every block, includes a context determination unit configured to refer to a result of comparing pieces of split-related information of one or a plurality of neighboring blocks adjacent to the target block to determine a context of split information of the target block, and a split information decoding unit configured to use the context determined by the context determination unit to decode the split information of the target block.

In an image decoding device according to an aspect of the disclosure, the split information is a split flag indicating whether or not to split the target block, and the split-related information is a depth of a block.

In an image decoding device according to an aspect of the disclosure, the split information is a split flag indicating whether or not the target block is to be split, and the split-related information is a block size.

In an image decoding device according to an aspect of the disclosure, the split information is a split flag indicating whether or not to split the target block, and the split-related information is a depth and a block size of a block.

In the image decoding device according to an aspect of the disclosure, the result of comparing the split-related information is an addition value of a difference value between the split-related information of the target block and the split-related information of the neighboring block.

In the image decoding device according to an aspect of the disclosure, the result of comparing the split-related information is a maximum value of a difference value between the split-related information of the target block and the split-related information of the neighboring block.

An image coding device according to an aspect of the disclosure, the image coding device being configured to code a picture for a block, includes a context determination unit configured to refer to a result of comparing pieces of split-related information of one or a plurality of neighboring blocks adjacent to the target block to determine a context of split information of the target block, and a split information coding unit configured to use the context determined by the context determination unit to code the split information of the target block.

In the image coding device according to an aspect of the disclosure, the split information is a split flag indicating whether or not to split the target block, and the split-related information is a depth of a block.

In the image coding device according to an aspect of the disclosure, the split information is a split flag indicating whether or not to split the target block, and the split-related information is a block size.

In the image coding device according to an aspect of the disclosure, the split information is a split flag indicating whether or not to split the target block, and the split-related information is a depth and a block size of a block.

In the image coding device according to an aspect of the disclosure, the result of comparing the split-related information is an addition value of a difference value between the split-related information of the target block and the split-related information of the neighboring block.

In the image coding device according to an aspect of the disclosure, the result of comparing the split-related information is a maximum value of a difference value between the split-related information of the target block and the split-related information of the neighboring block.

### Second Embodiment

Regarding a second embodiment of the disclosure, a description with reference to the drawings will be as follows. Note that the image decoding device 31 and the image coding device 11 according to the first embodiment can be similarly used in the present embodiment. Therefore, for convenience of explanation, descriptions of members having the same functions as those of the members described in the above-described embodiment will be omitted.

In the present embodiment, the context determination unit 32 derives a context of a split flag indicating whether or not to split a chrominance block that has not been split yet. To do so, the context determination unit 32 derives the context by referring to a luminance block that corresponds to the chrominance block and that has already been split and decoded.

### Context Determination Unit

The context determination unit 32 according to the present embodiment corresponds to a chrominance block (chrominance CB (a target block related to a first color component)), and obtains, from the CN information decoding unit 10, split-related information of a luminance block (luminance CB (a corresponding block related to a second color component)) that has already been split and decoded by the CN information decoding unit 10. Note that the chrominance CB is the target block (target CB) before decoding a split flag indicating whether or not to split the chrominance CB, and the luminance CB is the corresponding block (corresponding CB) corresponding to the target block. Also, the target block related to the first color component described above may be the luminance CB, and the corresponding block related to the second color component described above may be the chrominance CB.

In the context determination unit 32 according to the present embodiment, the context determination unit 32 refers to the split-related information of the obtained luminance CB, and determines whether a split line exists or not in the corresponding CB by identifying a split condition of the luminance CB corresponding block (corresponding CB).

In the context determination unit 32 according to the present embodiment, the context determination unit 32 determines the context of the target CB in accordance with the determined presence or absence of the split of the corresponding CB. Note that the context in the present embodiment is a context of whether or not to decode the QT split flag indicating whether or not to perform the QT split for the target CB.

### Context Determination Method

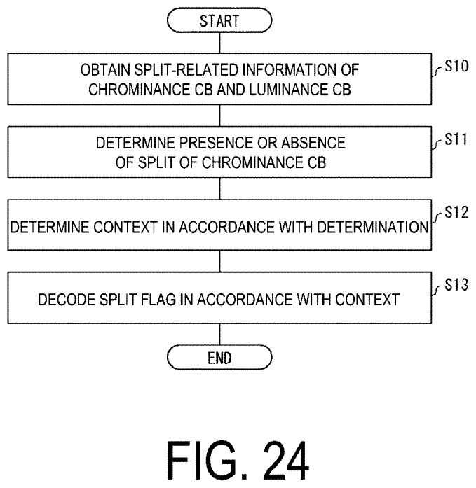

A context determination method performed by the image decoding device 31 according to the present embodiment will be described in detail with reference to FIG. 24. FIG. 24 is a flowchart diagram illustrating an example of a context determination method performed by the image decoding device 31 according to the present embodiment. Note that the detailed descriptions for the same steps as the context determination method according to the first embodiment are omitted.

The context determination unit 32 obtains, from the CN information decoding unit 10, the split-related information of the luminance CB (luminance block) that corresponds to the chrominance CB (chrominance block) and that has already been split and decoded by the CN information decoding unit 10 (step S10).

In addition, the context determination unit 32 refers to the obtained split-related information of the luminance CB to determine whether a split line exists or not in the corresponding CB by identifying a split situation of the luminance CB (corresponding CB) (step S11). A specific method of step S11 will be described later.

Additionally, the context determination unit 32 determines the context of the chrominance CB (target CB) in accordance with the determined presence or absence of the split of the luminance CB (corresponding CB) (step S12). A specific method of step S12 will be described later.

The CN information decoding unit 10 decodes the QT split flag indicating whether or not to perform the QT split for the target CB from CN information included in a CN in accordance with the context of the chrominance CB (target CB) determined by the context determination unit 32 (step S13).

### First Specific Example

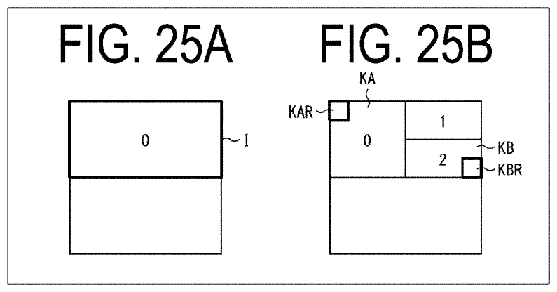

FIGS. 25A and 25B are diagrams illustrating step S11 of a context determination method according to the present specific example. FIG. 25A illustrates a chrominance CB, and FIG. 25B illustrates a luminance CB. Note that a number in each block in FIGS. 25A and 25B represents a partition number. The luminance CB (corresponding CB) includes a block KA and a block KB. Point coordinates on the upper left of the block KA are referred to as a point KAR, and point coordinates on the lower right of the block KB are referred to as a point KBR.

First, in step S11, the context determination unit 32 refers to the split-related information of the luminance CB to determine whether or not a partition number (partId_AboveLeft) of the block KA including the point KAR on the upper left of the luminance CB illustrated in FIG. 25B is different from the partition number (partId_LowerRight) of the block KB including a point KBR on the lower right of the luminance CB. Then, in step S12, the context determination unit 32 determines the result of the determination itself as the context of the split flag of the chrominance CB. The context equation is described below.

ctxIdxSplit=(partId_AboveLeft!=partId_LowerRight)

Note that in the above equation, in a case of the context of the QT split flag, ctxIdxSplit is ctxIdxQT. In a case of the context of the BT split flag, ctxIdxSplit is ctxIdxBT. In a case of the context of a flag of the PT split which is a split including the BT split and the TT split, without the BT split and the TT split being distinguished, ctxIdxSplit is ctxIdxPT.

In a case that the partition number of the block including the point KAR on the upper left of the luminance CB is different from the partition number of the block including the point KBR on the lower right of the luminance CB, the points KAR and KBR are individually included in different blocks, so the context determination unit 32 determines that a split line exists between the points KAR and KBR. On the other hand, in a case the partition number of the block including the point KAR on the upper left of the luminance CB is identical to the partition number of the block including the point KBR on the lower right of the luminance CB, the respective points KAR and KBR are included in the same block, so the context determination unit 32 determines that no split line exists between the points KAR and KBR.

As illustrated in FIG. 25B, the points KAR and KBR are included in different blocks KA and KB, respectively, and the context determination unit 32 outputs ctxIdxSplit=1 as the context of the split flag of the chrominance CB. In a case that the respective points KAR and KBR are included in the same block, the context determination unit 32 outputs ctxIdxSplit=0.

### Second Specific Example

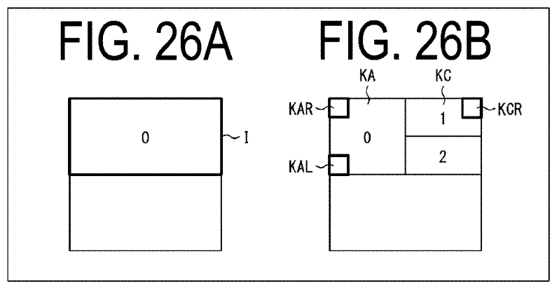

FIGS. 26A and 26B are diagrams illustrating step S11 of a context determination method according to the present specific example. FIG. 26A illustrates a chrominance CB (target CB), and FIG. 26B illustrates a luminance CB (corresponding CB). Note that a number in each block in FIGS. 26A and 26B represents a partition number. The luminance CB includes a block KA and a block KC. Point coordinates on the upper left of the block KA are referred to as a point KAR, and point coordinates on the lower left of the block KA are referred to as a point KAL. The point coordinates on the upper right of the block KC are referred to as a point KCR.

First, in step S11, the context determination unit 32 determines whether or not the partition number (partId_AboveLeft) of a corresponding block including the point KAR on the upper left of the luminance CB illustrated in FIG. 26B is different from the partition number (partId_AboveRight) of a corresponding block including the point KCR on the upper right of the luminance CB. The equation for the determination will be provided below.

splitHorizontally(=verSplit)=(partId_AboveLeft!=partId_AboveRight)

The context determination unit 32 determines whether or not the partition number (partId_AboveLeft) of the block including the point KAR on the upper left of the luminance CB is different from a partition number (partId_LowerLeft) of the block including the point KAL on the lower left of the luminance CB. The equation for the determination will be provided below.

splitVertically(=horSplit)=(partId_AboveLeft!=partId_LowerLeft)

In a case that the partition number of the block including the point KAR on the upper left of the luminance CB is different from the partition number of the block including the point KCR on the upper right of the luminance CB, the points KAR and KCR are individually included in different blocks, so the context determination unit 32 determines that a split line exists between the points KAR and KCR. On the other hand, in a case that the partition number of the block including the point KAR on the upper left of the luminance CB is identical to the partition number of the block including the point KCR on the upper right of the luminance CB, the respective points KAR and KCR are included in the same block, so the context determination unit 32 determines that no split line exists between the points KAR and KCR.

Also, in a case that the partition number of the block including the point KAR on the upper left of the luminance CB is different from the partition number of the block including the point KAL on the lower left of the luminance CB, the points KAR and KAL are individually included in different blocks, so the context determination unit 32 determines that a split line is present between the points KAR and KAL. On the other hand, in a case that the partition number of the block including the point KAR on the upper left of the luminance CB is identical to the partition number of the block including the point KAL on the lower left of the luminance CB, the respective points KAR and KAL are included in the same block, so the context determination unit 32 determines that no split line exists between the points KAR and KAL.

The context determination unit 32 outputs, as splitHorizontally, the result of whether or not the partition number of the block including the point KAR on the upper left of the luminance CB is different from the partition number of the block including the point KCR on the upper right of the luminance CB. As illustrated in FIG. 26B, the points KAR and KCR are included in the different blocks KA and KC, respectively, and the block KA and the block KC have different the partition numbers, so the context determination unit 32 configures splitHorizontally=1.

The context determination unit 32 outputs, as splitVertically, the result of whether or not the partition number of the block including the point KAR on the upper left of the luminance CB is different from the partition number of the block including the point KAL on the lower left of the luminance CB. As illustrated in FIG. 26B, the respective points KAR and KAL are included in the same corresponding block KA, the partition numbers are identical, so the context determination unit 32 configures splitVertically=0.

Next, in step S12, the context determination unit 32 refers to the configured splitVertically and splitHorizontally to determine ctxIdxSplit=splitVertically+splitHorizontally, which is a context of the split flag of the chrominance CB. In the case of the present specific example, splitVertically=0 and splitHorizontally=1 are satisfied, and thus the context determination unit 32 outputs ctxIdxSplit=1.

### Third Specific Example

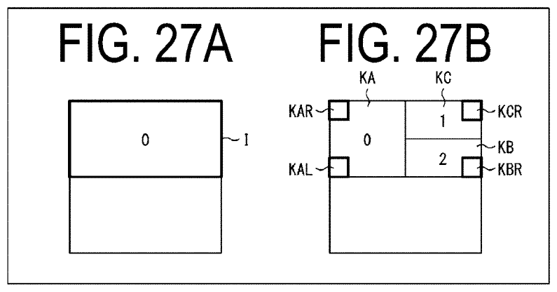

FIGS. 27A and 27B are diagrams illustrating step S11 of a context determination method according to the present specific example. FIG. 27A illustrates a chrominance CB (target CB), and FIG. 27B illustrates a luminance CB (corresponding CB). Note that a number in each block in FIGS. 27A and 27B represents a partition number. The luminance CB includes a block KA, a block KB, and a block KC. Point coordinates on the upper left of the block KA are referred to as a point KAR, and point coordinates on the lower left of the block KA are referred to as a point KAL. Additionally, the point coordinates on the lower right of the block KB are referred to as a point KBR. The point coordinates on the upper right of the block KC are referred to as a point KCR.

First, in step S11, as illustrated in FIG. 27B, the context determination unit 32 determines whether or not a partition number (partId_AboveLeft) of a block including the point KAR on the upper left of the luminance CB is different from a partition number (partId_AboveRight) of a block including the point KCR on the upper right of the luminance CB. As illustrated in FIG. 27B, the context determination unit 32 also determines whether or not a partition number (partId_LowerLeft) of a block including the point KAL on the lower left of the luminance CB is different from a partition number (partId_LowerRight) of a block including the point KBR on the lower right of the luminance CB. With reference to these determinations, the context determination unit 32 calculates splitHorizontally indicated by the following equation.

splitHorizontally(=verSplit)=(partId_AboveLeft!=partId_AboveRight)+(partId_LowerLeft!=partId_LowerRight)

The context determination unit 32 determines whether or not the partition number (partId_AboveLeft) of the block including the point KAR on the upper left of the luminance CB is different from the partition number (partId_LowerLeft) of the block including the point KAL on the lower left of the luminance CB. The context determination unit 32 determines whether or not the partition number (partId_AboveRight) of the block including the point KCR on the upper right of the luminance CB is different from the partition number (partId_lowerRight) of the block including the point KBR on the lower right of the luminance CB. With reference to these determinations, the context determination unit 32 calculates splitVertically indicated by the following equation.

splitVertically(=horSplit)=(partId_AboveLeft!=partId_LowerLeft)+(partId_AboveRight!=partId_LowerRight)

In a case that the partition number of the block including the point KAR on the upper left of the luminance CB is different from the partition number of the block including the point KCR on the upper right of the luminance CB, the points KAR and KCR are individually included in different blocks, so the context determination unit 32 determines that a split line exists between the points KAR and KCR. On the other hand, in a case that the partition number of the block including the point KAR on the upper left of the luminance CB is identical to the partition number of the block including the point KCR on the upper right of the luminance CB, the respective points KAR and KCR are included in the same block, so the context determination unit 32 determines that no split line exists between the points KAR and KCR.

Also, in a case that the partition number of the block including the point KAL on the lower light of the luminance CB is different from the partition number of the block including the point KBR on the lower right of the luminance CB, the respective points KAL and KBR are individually included in different blocks, so the context determination unit 32 determines that a split line is present between the points KAL and KBR. On the other hand, in a case that the partition number of the block including the point KAL on the lower left of the luminance CB is identical to the partition number of the block including the point KBR on the lower right of the luminance CB, the respective points KAL and KBR are included in the same block, so the context determination unit 32 determines that no split line exists between the points KAL and KBR.

Also, in a case that the partition number of the block including the point KAR on the upper left of the luminance CB is different from the partition number of the block including the point KAL on the lower left of the luminance CB, the points KAR and KAL are individually included in different blocks, so the context determination unit 32 determines that a split line is present between the points KAR and KAL. On the other hand, in a case that the partition number of the block including the point KCR on the lower right of the luminance CB is identical to the partition number of the block including the point KBR on the lower right of the luminance CB, the respective points KCR and KBR are included in the same block, so the context determination unit 32 determines that no split line sandwiched by two different blocks exists between the points KCR and KBR.

As illustrated in FIG. 27B, the points KAR and KCR are included in different blocks KA and KC, respectively, and because the block KA and block KC have the different partition numbers, the context determination unit 32 configures (partId_AboveLeft!=partId_AboveRight)=1. Additionally, the points KAL and KBR are included in different blocks KA and KB, respectively, and because the blocks KA and KB have the different partition numbers, the context determination unit 32 configures (partId_LowerLeft!=partId_LowerRight)=1. Accordingly, the context determination unit 32 configures splitHorizontally=2 according to the above-described equation.

Additionally, as illustrated in FIG. 27B, the respective points KAR and KAL are included in the same block KA, and because the partition numbers are identical, the context determination unit 32 configures (partId_AboveLeft!=partId_LowerLeft)=0. Additionally, the points KCR and KBR are included in the different blocks KC and KB, respectively, and because the blocks KC and KB have the different partition numbers, the context determination unit 32 configures (partId_AboveRight!=partId_LowerRight)=1. Accordingly, the context determination unit 32 configures splitVertically=1 according to the above-described equation.

Next, in step S12, the context determination unit 32 refers to the configured splitVertically and splitHorizontally to determine ctxIdxSplit=splitVertically+splitHorizontally, which is a context of the split flag of the chrominance CB. In the case of the present specific example, splitVertically=1 and splitHorizontally=2 are satisfied, and thus the context determination unit 32 outputs ctxIdxSplit=3. Note that ctxIdxSplit in the present specific example can take five values of 0 to 4, but can also take three values of 0 to 2. In that case, in a case that splitVertically or splitHorizontally described above is 1 or 2 (i.e., at least one or more split lines exist), splitVertically or splitHorizontally is 1. The equation where ctxIdxSplit takes the three values of 0 to 2 will be indicated below.

ctxIdxSplit=splitVertically?1:0+splitHorizontally?1:0

Alternatively, in a case that splitVertically+splitHorizontally is equal to or larger than 3, as in the following equation, ctxIdxSplit may be 2.

ctxIdxSplit=min(2, splitVertically+splitHorizontally)

### Image Coding Device

The configuration of the image decoding device 31 according to the present embodiment can also be applied to the image coding device 11. In such a case, the image coding device 11 includes a CN information coding unit (not illustrated) instead of the CN information decoding unit 10, and the context determination unit 32, and derives the context of the split flag (QT split flag, BT split flag, TT split flag, or the like) indicating whether to split the target block or not.

In the image coding device 11 having the configuration described above, the context determination unit 32 obtains the split-related information of the luminance block (corresponding block) that has already been split and that corresponds to the chrominance block (target block). Next, the context determination unit 32 determines whether or not a split line exists in the corresponding block by identifying a split situation of the corresponding block. Next, the context determination unit 32 determines the context of the split flag of the target block in response to the determination. Next, the CN information coding unit codes the split flag indicating whether or not to split the target block depending on the context determined by the context determination unit 32.

### Summary of Second Embodiment

As described above, the image decoding device 31 according to the present embodiment determines the context of the split information (split flag) of the target block associated with the first color component by referring to the split situation of the corresponding block associated with the second color component that has already been decoded, and uses the context to decode the split information of the target block associated with the first color component. As a result, the split information of the target block is decoded in accordance with the split situation of the corresponding block.

The image decoding device 31 according to the present embodiment also determines, by identifying the split situation of the corresponding block associated with the second color component with reference to the partition number of the corresponding block, the presence or absence of a split line of the corresponding block associated with the second color component, and with reference to the determination, determines the context of the split flag of the target block associated with the first color component. With this, the image decoding device 31 can determine a more appropriate context, because the image decoding device 31 determines the presence or absence of the split of the first component with reference to the partition number of the corresponding block associated with the second color component. Accordingly, in the image decoding device, the code amount of the split information can be reduced.

### Third Embodiment

A third embodiment of the disclosure will be described below with reference to the drawings. Note that in the present embodiment as well, the image decoding device 31 and the image coding device 11 according to the first embodiment can be similarly used. Therefore, for convenience of explanation, descriptions of members having the same functions as those of the members described in the above-described embodiment will be omitted.

### First Aspect of Third Embodiment

In the present aspect, a context is derived by the same method as the context determination method according to the first embodiment. However, the context of the present embodiment is a context of a direction flag (split mode) indicating a split direction of the target block. In the present aspect, the context determination unit 32 determines the presence or absence of the split or the split direction of the neighboring block by a method similar to that of the first embodiment, and derives the context of the BT direction flag for the target block based on the determination.

### CN Information Decoding Unit

The CN information decoding unit 10 decodes the BT direction flag from the CN information included in the CN in accordance with a context (which will be described later) on whether or not to decode the BT direction flag (split information in the claims) indicating a split method of the BT split of the target CN. Then, the CN information decoding unit 10 recursively splits and decodes the target CN by the split method indicated by the BT direction flag until the BT direction flag does not signal to additional splits. Finally, the tree unit footer CTUF is decoded from the CTU information.

### Context Determination Unit

The context determination unit 32 according to the present aspect obtains, from the CN information decoding unit 10, split-related information of the target CN which has not yet been split by the CN information decoding unit 10, and split-related information of the neighboring CN which is adjacent to the target CN and has already been split and decoded by the CN information decoding unit 10.

The context determination unit 32 according to the present aspect determines, by referring to the obtained partition number, horizontal depth and vertical depth, or size of the neighboring CN and specifying a split situation of the neighboring block, the presence or absence of the split or the split direction of the neighboring block.

Additionally, in the context determination unit 32 according to the present aspect, the context determination unit 32 determines the context of the direction flag (split mode) indicating the split direction of the target block in accordance with the determined presence or absence of the split or split direction. The context determined by the context determination unit 32 is output to the above-described CN information decoding unit 10.

### Context Determination Method

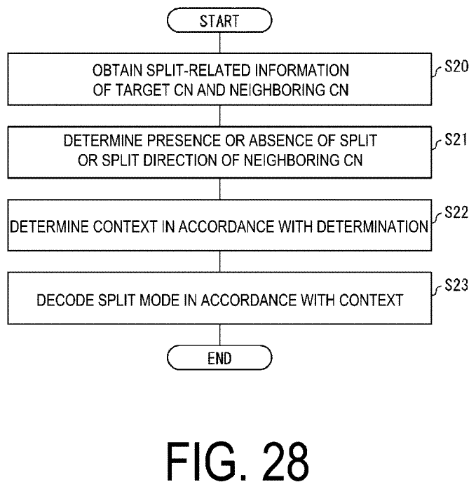

The context determination method by the image decoding device 31 according to the present aspect will be described in detail with reference to FIG. 28. FIG. 28 is a flowchart diagram illustrating an example of the context determination method performed by the image decoding device 31 according to the present aspect. Note that detailed descriptions for the same processes as those of the context determination methods according to the first embodiment and the second embodiment are omitted.

First, the context determination unit 32 obtains, from the CN information decoding unit 10, the target CN (target block) which has not yet been split by the CN information decoding unit 10, and the neighboring CN (neighboring block) which is adjacent to the target CN and has already been split and decoded by the CN information decoding unit 10 (step S20).

Next, the context determination unit 32 determines, by referring to the partition number, the horizontal depth and vertical depth, or the size of each of the target CN and the neighboring CN and specifying the split situation of the neighboring block, the presence or absence of the split or the split direction of the neighboring block (step S21). Note that a specific method of step S21 will be described later.

Next, the context determination unit 32 determines the context in accordance with the determined presence or absence of the split or split direction (step S22). Note that a specific method of step S22 will be described later.

Next, the CN information decoding unit 10 decodes, in accordance with the context determined by the context determination unit 32, from the information included in the CN, the BT direction flag indicating the split method of the BT split of the target CN (step S23).

### Specific Example 1

In Specific Example 1 of the present aspect, the context determination unit 32 configures splitHorizontally and splitVertically, which are results of determining the presence or absence of a split line in step S21, similar to the specific example of the first embodiment. In Specific Example 1 of the present aspect, splitHorizontally and splitVertically are determined by the same method as splitHorizontally and splitVertically in the specific examples of the first embodiment. As such, detailed descriptions of processes for splitHorizontally and splitVertically in step S21 are omitted. Additionally, the context determination unit 32 refers to width, which is the width of the target block, and height, which is the height of the target block, as the split-related information.

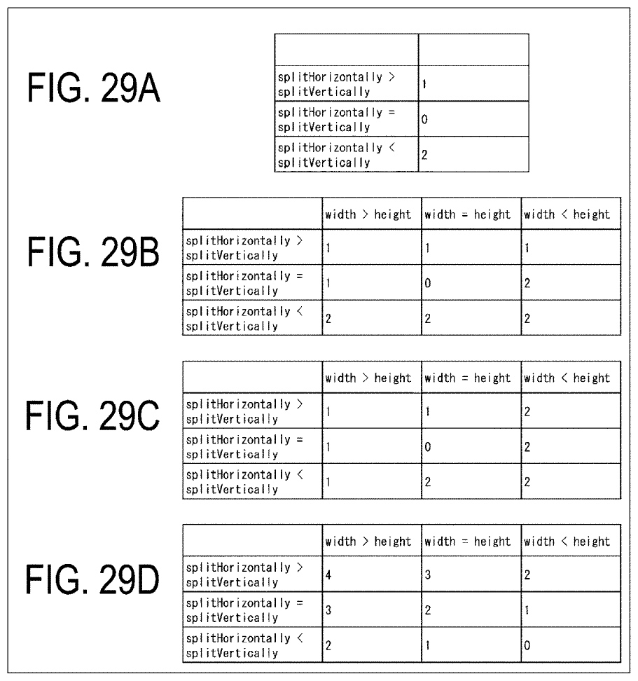

First, a method for determining the context with reference to splitHorizontally and splitVertically will be described. FIG. 29A is a table for describing the method for determining the context with reference to splitHorizontally and splitVertically. Note that, in the following, for the sake of simplicity, a certain block being split into two blocks aligned in the horizontal direction is assumed to be being split horizontally (vertical split), and a certain block being split into two blocks aligned in the vertical direction is assumed to be being split vertically (horizontal split).

In step S22, the context determination unit 32 determines the context (ctxIdxDir) by determining whether or not splitHorizontally is greater than splitVertically. Expressions for the determination are provided below.

if (splitHorizontally>splitVertically) ctxIdxDir=1

else if (splitHorizontally<splitVertically) ctxIdxDir=2

else ctxIdxDir=0

Note that by using verSplit and horSplit, the following expressions are obtained.

if (verSplit>horSplit) ctxIdxDir=1

else if (verSplit<horSplit) ctxIdxDir=2

else ctxIdxDir=0

To be more specific, as illustrated in FIG. 29A, in a case that splitHorizontally is greater than splitVertically, the context determination unit 32 determines the context as ctxIdxDir=1. The expression ctxIdxDir=1 indicates that the neighboring block (or corresponding block) is horizontally split/split horizontally (vertical split/verSplit, split in left and right), the target block is also highly likely to be split horizontally (vertical split), and the CN information decoding unit 10 is highly likely to decode the direction flag indicating whether or not the target block is to be split horizontally (vertical split).

In addition, in a case that splitHorizontally is the same as splitVertically, the context determination unit 32 determines the context as ctxIdxDir=0. The expression ctxIdxDir=0 indicates that, since both the horizontal split and the vertical split of the neighboring block (or corresponding block) are performed the same number of times, the CN information decoding unit 10 is highly likely to decode the direction flag of the vertical split or the horizontal split of the target block with an equal probability.

In addition, in a case that splitHorizontally is smaller than splitVertically, the context determination unit 32 determines the context as ctxIdxDir=2. The expression ctxIdxDir=2 indicates that the neighboring block (or the corresponding block) is split vertically (horizontal split, split up and down), and the target block is also highly likely to be split vertically (horizontal split), and the CN information decoding unit 10 is highly likely to decode the direction flag indicating whether or not the target block is to be split vertically (horizontal split).

Next, a method for determining the context with preferential reference to splitHorizontally and splitVertically and with reference to width and height will be described. FIG. 29B is a table for describing the method for determining the context with preferential reference to splitHorizontally and splitVertically and with reference to width and height.

In step S22, the context determination unit 32 determines the context (ctxIdxDir) by determining whether or not splitHorizontally is greater than splitVertically. In a case that it cannot be determined whether or not splitHorizontally is greater than splitVertically (for example, in a case that splitHorizontally and splitVertically are equal to each other), the context determination unit 32 determines the context (ctxIdxDir) by determining whether or not width is greater than height. Expressions for these determinations are provided below.

if (splitHorizontally>splitVertically) ctxIdxDir=ctxA

else if (splitHorizontally<splitVertically) ctxIdxDir=ctxB

else if (width>height) ctxIdxDir=ctxA

else if (width<height) ctxIdxDir=ctxB

else ctxIdxDir=ctxC

Here, ctxA, ctxB, and ctxC are values for specifying the contest. For example, ctxA=1, ctxB=2, and ctxC=0 may be used, but the values thereof are not limited to these values. For example, ctxA=0, ctxB=1, and ctxC=2 or the like may be used. In other words, since context variables specified by the context (context index) are used to distinguish contexts, it is sufficient that the values are different from one another depending on the branch results, and the size relationship may be different (the same applies below). Here, by using ctxA, ctxB, and ctxC, it is indicated that the contexts in a case that splitHorizontally>splitVertically is true and in a case that the subsequent width>height is true have the same value of ctxA, the contexts in a case that splitHorizontally<splitVertically is true and in a case that the subsequent width<height is true have the same value of ctxB, and the value of ctxA and the value of ctxB of the above-described two contexts are different from each other.

Note that by using verSplit and horSplit, the following expressions are obtained.

if (verSplit>horSplit) ctxIdxDir=ctxA

else if (verSplit<horSplit) ctxIdxDir=ctxB

else if (width>height) ctxIdxDir=ctxA

else if (width<height) ctxIdxDir=ctxB

else ctxIdxDir=ctxC

To be more specific, first, the context determination unit 32 determines whether or not splitHorizontally is greater than splitVertically, and as illustrated in FIG. 29B, in a case that splitHorizontally is greater than splitVertically, determines the context as ctxIdxDir=1. In a case that splitHorizontally is not greater than splitVertically, the context determination unit 32 determines the context as ctxIdxDir=2. In a case that splitHorizontally and splitVertically are equal to each other, the context determination unit 32 determines whether or not width, which is the width of the target block, is greater than height, which is the height of the target block. In a case that width is greater than height, the context determination unit 32 determines the context as ctxIdxDir=1. Here, the reason for the context determination unit 32 to determine the context as ctxIdxDir=1 is because, in a case that width is greater than height, that is, in a case that the target block is a rectangle that is longer in the horizontal direction than in the vertical direction, the target block is highly likely to be split horizontally (vertical split).

In addition, in a case that width is smaller than height, the context determination unit 32 determines the context as ctxIdxDir=2. Here, the reason for the context determination unit 32 to determine the context as ctxIdxDir=2 is because, in a case that width is smaller than height, that is, in a case that the target block is a rectangle that is longer in the vertical direction than in the horizontal direction, the target block is highly likely to be split vertically (horizontal split).

Additionally, in a case that width and height are equal to each other, the context determination unit 32 determines the context as ctxIdxDir=0. Here, the reason for the context determination unit 32 to determine the context as ctxIdxDir=0 is because, in a case that width and height are equal to each other, that is, in a case that the target block is a square in which the side in the horizontal direction and the side in the vertical direction are equal to each other in length, the split directions of the target block occur at an equal probability.

Next, a method for determining the context with preferential reference to width and height and with reference to splitHorizontally and splitVertically will be described. FIG. 29C is a table for describing the method for determining the context with preferential reference to width and height and with reference to splitHorizontally and splitVertically.

In step S22, the context determination unit 32 determines the context (ctxIdxDir) by determining whether or not width is greater than height. In a case that it cannot be determined whether or not width is greater than height (for example, in a case that width and height are equal to each other), the context determination unit 32 determines the context (ctxIdxDir) by determining whether or not splitHorizontally is greater than splitVertically. Expressions for these determinations are provided below.

if (width>height) ctxIdxDir=ctxA

else if (width<height) ctxIdxDir=ctxB

else if (splitHorizontally>splitVertically) ctxIdxDir=ctxA

else if (splitHorizontally<splitVertically) ctxIdxDir=ctxB

else ctxIdxDir=ctxC

Note that by using verSplit and horSplit, the following expressions are obtained.

if (width>height) ctxIdxDir=ctxA

else if (width<height) ctxIdxDir=ctxB

else if (verSplit>horSplit) ctxIdxDir=ctxA

else if (verSplit<horSplit) ctxIdxDir=ctxB

else ctxIdxDir=ctxC

To be more specific, the context determination unit 32 determines whether or not width is greater than height, and as illustrated in FIG. 29C, in a case that width is greater than height, the context determination unit 32 determines the context as ctxIdxDir=1. In a case that width is smaller than height, the context determination unit 32 determines the context as ctxIdxDir=2.

Next, in a case that width and height are equal to each other, the context determination unit 32 determines whether or not splitHorizontally is greater than splitVertically. In a case that splitHorizontally is greater than splitVertically, the context determination unit 32 determines the context as ctxIdxDir=1. In addition, in a case that splitHorizontally is smaller than splitVertically, the context determination unit 32 determines the context as ctxIdxDir=2. In addition, in a case that splitHorizontally and splitVertically are equal to each other, the context determination unit 32 determines the context as ctxIdxDir=0.

In each of the methods described above, the example has been described in which the value of the context takes a value in three stages of 0 to 2, but the value of the context may take a value in five levels of 0 to 4. FIG. 29D is a table for describing an example in which the value of the context takes a value in five levels of 0 to 4.

First, in step S22, the context determination unit 32 determines whether or not splitHorizontally is greater than splitVertically. In a case that splitHorizontally is not greater than splitVertically, the context determination unit 32 further determines whether or not splitHorizontally and splitVertically are equal to each other. Additionally, the context determination unit 32 determines whether or not width is greater than height. In a case that width is not greater than height, it is further determined whether or not width and height are equal to each other. The context determination unit 32 determines the context (ctxIdxDir) by referring to the determination using splitHorizontally and splitVertically and the determination using width and height. An expression for these determinations is provided below.

ctxIdxDir=(splitHorizontally>splitVertically)?2:(splitHorizontally==splitVertically)?1:0+(width>height)?2:(width==height)?1:0

To be more specific, first, the context determination unit 32 determines whether or not splitHorizontally is greater than splitVertically, and in a case that splitHorizontally is greater than splitVertically, configures the component of the context according to the determination using splitHorizontally and splitVertically to 2. In a case that splitHorizontally is not greater than splitVertically, the context determination unit 32 further determines whether or not splitHorizontally and splitVertically are equal to each other. In a case that splitHorizontally and splitVertically are equal to each other, the context determination unit 32 configures the component of the context according to the determination using splitHorizontally and splitVertically to 1. In a case that splitHorizontally and splitVertically are not equal to each other, the context determination unit 32 configures the component of the context according to the determination using splitHorizontally and splitVertically to 0.

In addition, the context determination unit 32 determines whether or not width is greater than height, and in a case that width is greater than height, configures the component of the context according to the determination using width and height to 2. In a case that width is not greater than height, the context determination unit 32 further determines whether or not width and height are equal to each other. In a case that width and height are equal to each other, the context determination unit 32 configures the component of the context according to the determination using width and height to 1. In a case that width and height are not equal to each other, the context determination unit 32 configures the component of the context according to the determination using width and height to 0.

Next, the context determination unit 32 determines ctxIdxDir by adding the component of the context according to the determination using splitHorizontally and splitVertically and the component of the context according to the determination using width and height. The value of ctxIdxDir determined through this may be 0 to 4. Furthermore, as ctxIdxDir approaches 4, it is indicated that the neighboring block (or corresponding block) is highly likely to be split horizontally (vertical split), the target block is also highly likely to be split horizontally, and the CN information decoding unit 10 is highly likely to decode the direction flag indicating whether or not the target block is to be split horizontally. Furthermore, as ctxIdxDir approaches 0, it is indicated that the neighboring block is highly likely to be split vertically (horizontal split), the target block is also highly likely to be split vertically, and the CN information decoding unit 10 is highly likely to decode the direction flag indicating whether or not the target block is to be split vertically.

Furthermore, as ctxIdxDir approaches 4, it may be indicated that the neighboring block is highly likely to be split vertically (horizontal split), the target block is also highly likely to be split vertically (horizontal split), and the CN information decoding unit 10 is highly likely to decode the direction flag indicating whether or not the target block is to be split vertically. In the same manner, as ctxIdxDir approaches 0, it may be indicated that the neighboring block is highly likely to be split horizontally (vertical split), the target block is also highly likely to be split horizontally (vertical split), and the CN information decoding unit 10 is highly likely to decode the direction flag indicating whether or not the target block is to be split horizontally. An expression for the determination in that case is provided below.

ctxIdxDir=(splitHorizontally>splitVertically)?0:(splitHorizontally==splitVertically)?1:2+(width>height)?0:(width==height)?1:2

Note that by using verSplit and horSplit, the following expression is obtained.

ctxIdxDir=(verSplit>horSplit)?0:(verSplit==horSplit)?1:2+(width>height)?0:(width==height)?1:2

### Specific Example 2

In Specific Example 1 described above, the method has been described in which the context determination unit 32 determines the context (ctxIdxDir) of the BT split direction flag (bt_dir_flag). The context determined by the method is assumed to be used by the image decoding device 31 according to the present embodiment at the time of decoding the BT split direction flag (bt_dir_flag) after decoding the BT split flag (bt_split_flag). That is, in BT split binarization, the presence or absence of the split is specified at a first bit, and the split direction is specified at a second bit. However, the image decoding device 31 according to the present embodiment may decode a split flag (bt_split_vertically_flag/bt_hor_split_flag) indicating whether or not to split vertically and a split flag (bt_split_horizontally_flag/bt_ver_split_flag) indicating whether or not to split horizontally instead of decoding the BT split flag (bt_split_flag) and the BT split direction flag (bt_dir_flag). That is, in the BT split binarization, the presence or absence of the horizontal split (whether or not being split vertically is performed) may be specified at the first bit, and the presence or absence of the vertical split (whether or not being split horizontally is performed) may be specified at the second bit. In this case, in a case that there is no vertical split and horizontal split, it can be assumed that there is no split. Note that a vertical split flag is a flag indicating whether or not the target block is to be split horizontally. Additionally, a horizontal split flag is a flag indicating whether or not the target block is to be split vertically. A method for determining the context (ctxIdxBTVertically) of the horizontal split flag (bt_split_vertically_flag) and the context (ctxIdxBTHorizontally) of the vertical split flag (bt_split_horizontally_flag) will be described below.

First, as in Specific Example 1, a method for determining the context with reference to splitHorizontally and splitVertically will be described. In step S22, the context determination unit 32 determines whether or not splitVertically is greater than 0. In a case that splitVertically is greater than 0, the context determination unit 32 determines the context as ctxIdxBTVertically=1. The expression ctxIdxBTVertically=1 indicates that the target block is highly likely to be split vertically (horizontal split, split up and down), and the CN information decoding unit 10 is highly likely to decode the direction flag indicating whether or not the target block is to be split vertically. In a case that splitVertically is not greater than 0, the context determination unit 32 determines the context as ctxIdxBTVertically=0. The expression ctxIdxBTVertically=1 indicates that the target block is less likely to be split vertically, and the CN information decoding unit 10 is less likely to decode the direction flag of being split vertically of the target block. An expression for the determination is provided below.

ctxIdxBTVertically=(splitVertically>0)?1:0

Additionally, the context determination unit 32 determines whether or not splitHorizontally is greater than 0. In a case that splitHorizontally is greater than 0, the context determination unit 32 determines the context as ctxIdxBTHorizontally=1. The expression ctxIdxBTHorizontally=1 indicates that the target block is highly likely to be split horizontally (vertical split, split in left and right), and the CN information decoding unit 10 is highly likely to decode the direction flag indicating whether or not the target block is to be split horizontally. In a case that splitHorizontally is not greater than 0, the context determination unit 32 determines the context as ctxIdxBTHorizontally=0. The expression ctxIdxBTVHorizontally=0 indicates that the target block is less likely to be split horizontally, and the CN information decoding unit 10 is less likely to decode the direction flag indicating whether or not the target block is to be split horizontally. An expression for the determination is provided below.

ctxIdxBTHorizontally=(splitHorizontally>0)?1:0

Next, a method for determining the context with preferential reference to splitHorizontally and splitVertically and with reference to width and height will be described. In step S22, the context determination unit 32 determines whether or not splitVertically is greater than 0. In a case that splitVertically is greater than 0, the context determination unit 32 determines the context as ctxIdxBTVertically=1. In a case that splitVerticallyt is not greater than 0, the context determination unit 32 determines whether or not width, which is the width of the target block, is smaller than height, which is the height of the target block.

In a case that width is smaller than height, the context determination unit 32 determines the context as ctxIdxBTVertically=1. In a case that width is not smaller than height, the context determination unit 32 determines the context as ctxIdxBTVertically=0. An expression for these determinations is provided below.

ctxIdxBTVertically=(splitVertically>0)?1:(width<height)?1:0

Additionally, the context determination unit 32 determines whether or not splitHorizontally is greater than 0. In a case that splitHorizontally is greater than 0, the context determination unit 32 determines the context as ctxIdxBTHorizontally=1. In a case that splitHorizontally is not greater than 0, the context determination unit 32 determines whether or not width, which is the width of the target block, is greater than height, which is the height of the target block. In a case that width is greater than height, the context determination unit 32 determines the context as ctxIdxBTHorizontally=1. In a case that width is not greater than height, the context determination unit 32 determines the context as ctxIdxBTHorizontally=0. An expression for these determinations is provided below.

ctxIdxBTHorizontally=(splitHorizontally>0)?1:(width>height)?1:0

Next, a method for determining the context with preferential reference to width and height and with reference to splitHorizontally and splitVertically will be described. In step S22, the context determination unit 32 determines whether or not width, which is the width of the target block, is smaller than height, which is the height of the target block. In a case that width is smaller than height, the context determination unit 32 determines the context as ctxIdxBTVertically=1. In a case that width is not smaller than height, the context determination unit 32 determines whether or not splitVertically is greater than 0. In a case that splitVertically is greater than 0, the context determination unit 32 determines the context as ctxIdxBTVertically=1. In a case that splitVertically is not greater than 0, the context determination unit 32 determines the context as ctxIdxBTVertically=0. An expression for these determinations is provided below.

ctxIdxBTVertically=(width<height)?1:(splitVertically>0)?1:0

Additionally, the context determination unit 32 determines whether or not width, which is the width of the target block, is greater than height, which is the height of the target block. In a case that width is greater than height, the context determination unit 32 determines the context as ctxIdxBTHorizontally=1. In a case that width is not greater than height, the context determination unit 32 determines whether or not splitHorizontally is greater than 0. In a case that splitHorizontally is greater than 0, the context determination unit 32 determines the context as ctxIdxBTHorizontally=1. In a case that splitHorizontally is not greater than 0, the context determination unit 32 determines the context as ctxIdxBTHorizontally=0.

### Summary of First Aspect of Third Embodiment

As described above, the image decoding device 31 according to the present aspect determines the context of the direction flag for indicating the split direction of the target block with reference to the split situation of at least one neighboring block adjacent to the target block, and decodes the direction flag by using the context. With this, since the direction flag is decoded in accordance with the split situation of the neighboring block, in a case that the neighboring block has not been split and the target block is also highly likely not to be split, it is possible to reduce the possibility of decoding an unnecessary direction flag. Accordingly, in the image decoding device, a code amount of the split information can be reduced.

In addition, the image decoding device 31 according to the present aspect determines, by referring to the partition number, the horizontal depth and vertical depth, or the size of the neighboring block and identifying the split situation of the neighboring block, the presence or absence of the split line or the split direction of the neighboring block, and determines the context by referring to the determination. Thus, since the reference of the partition number, the horizontal depth and vertical depth, or the size of the neighboring block is performed, the determination to which the split-related information of the neighboring block is reflected can be performed and a more appropriate context can be determined.

### Second Aspect of Third Embodiment

In the present aspect, the context is derived by the same method as the context determination method according to the second embodiment. However, the context of the present embodiment is a context of the direction flag indicating the split method of the target block. In the present aspect, the context determination unit 32 determines the presence or absence of the split or the split direction of the corresponding block by specifying the split situation of the corresponding block by the method similar to that of the second embodiment, and derives the context of the direction flag of the target block based on the determination. Note that the CN information decoding unit 10 according to a second aspect of the third embodiment has the same function as the function of the first aspect of the third embodiment described above.

### Context Determination Unit

The context determination unit 32 according to the present aspect obtains, from the CN information decoding unit 10, the split-related information of the luminance block (luminance CB (a corresponding block relating to a second color component in the claims) which corresponds to a chrominance block (chrominance CB (a target block relating to a first color component in the claims)), which has not yet been split by the CN information decoding unit 10, and has been already split and decoded by the CN information decoding unit 10.

Furthermore, the context determination unit 32 according to the present aspect determines, by referring to the obtained split-related information of the luminance CB and specifying a split situation of the luminance CB (corresponding CB) corresponding to the chrominance CB (target CB), the presence or absence of the split or the split direction of the corresponding CB.

Additionally, in the context determination unit 32 according to the present aspect, the context determination unit 32 determines the context of the direction flag indicating the split direction of the target CB in accordance with the determined split situation. The context determined by the context determination unit 32 is output to the above-described CN information decoding unit 10.

### Context Determination Method

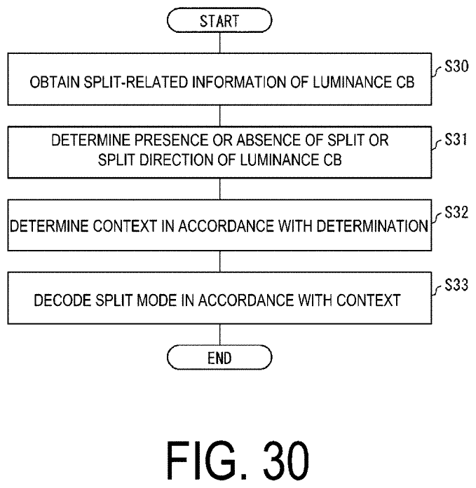

A context determination method by the image decoding device 31 according to the present aspect will be described in detail with reference to FIG. 30. FIG. 30 is a flowchart diagram illustrating an example of the context determination method performed by the image decoding device 31 according to the present aspect. Note that detailed descriptions for the same processes as those of the context determination methods according to the first embodiment and the second embodiment and the first aspect of the third embodiment will be omitted.

The context determination unit 32 obtains, from the CN information decoding unit 10, split-related information for the luminance CB (corresponding CB) which corresponds to the chrominance CB (target CB), which has not yet been split by the CN information decoding unit 10, and has already been split and decoded by the CN information decoding unit 10 (step S30).

The context determination unit 32 determines, by referring to the obtained split-related information of the luminance CB and specifying the split situation of the luminance CB corresponding to the chrominance CB, the presence or absence of the split or the split direction of the corresponding CB (step S31).

The context determination unit 32 determines the context of the target CB in accordance with the determined presence or absence of the split or split direction of the corresponding CB (step S32).

The CN information decoding unit 10 decodes, in accordance with the context determined by the context determination unit 32, from the CN information included in the CN, the BT direction flag indicating the split method of the BT split of the target CB (step S33).

### Specific Example

In a specific example of the present aspect as well, the context determination unit 32 can perform the same methods as Specific Example 1 and Specific Example 2 of the first aspect of the third embodiment. Therefore, detailed descriptions of the specific example of the present aspect will be omitted.

In the present aspect, in step S31, the context determination unit 32 configures splitHorizontally indicating whether or not the corresponding block is split horizontally (vertical split) and splitVertically indicating whether or not the corresponding block is split vertically (horizontal split). The context determination unit 32 determines the context (ctxIdxDir) of the direction flag indicating the split direction of the target block, based on splitHorizontally and splitVertically by using the same method as Specific Example 1 and Specific Example 2 of the first aspect of the third embodiment, and based on width, which is the width of the target block, and height, which is the height of the target block, as necessary.

### Summary of Second Aspect of Third Embodiment

As described above, the image decoding device 31 according to the present aspect determines the context of the direction flag for indicating the split direction of the target block relating to the first color component, with reference to the split situation of the corresponding block relating to the second color component which has already been decoded, and decodes the direction flag by using the context. With this, since the direction flag is decoded in accordance with the split situation of the corresponding block, in a case that the corresponding block is not split and the target block is also highly likely not to be split, it is possible to reduce the possibility of decoding the unnecessary direction flag. Accordingly, in the image decoding device, the code amount of the split information can be reduced.

In addition, the image decoding device 31 according to the present aspect determines, by referring to the partition number of the corresponding block and specifying the split situation of the corresponding block, the presence or absence of the split line or the split direction of the corresponding block, and determines the context of the target block by referring to the determination. With this, since the reference of the partition number of the corresponding block is performed, it is possible to determine a more appropriate context to which the split-related information of the corresponding block is reflected.

### Image Coding Device

The configuration of the image decoding device 31 according to the present embodiment can similarly be applied to the image coding device 11. In such a case, the image coding device 11 includes a CN information coding unit (not illustrated) instead of the CN information decoding unit 10, and the context determination unit 32, and derives the context of the split direction flag (BT split direction flag, TT split direction flag, or the like) indicating whether or not to split the target block.

In the image coding device 11 including the configuration described above, the context determination unit 32 obtains the split-related information of the luminance block (corresponding block) that corresponds to the neighboring block of the chrominance block (target block) or the chrominance block and has already been split. Next, the context determination unit 32 performs, by referring to these pieces of split-related information and specifying the split situation of the neighboring block or the corresponding block, determination of whether or not there is the split line of the neighboring block or the corresponding block, or determination of the split direction of neighboring block or the corresponding block. Next, in accordance with the determination, the context determination unit 32 determines the context of the split direction flag indicating the split direction of the target block. Next, the CN information coding unit codes the split direction flag indicating the split direction of the target block in accordance with the context determined by the context determination unit 32.

### Implementation Examples by Software

Note that, part of the image coding device 11 and the image decoding device 31 in the above-mentioned embodiments, for example, the entropy decoding unit 301, the prediction parameter decoding unit 302, the loop filter 305, the prediction image generation unit 308, the inverse quantization and inverse DCT unit 311, the addition unit 312, the prediction image generation unit 101, the subtraction unit 102, the DCT and quantization unit 103, the entropy coding unit 104, the inverse quantization and inverse DCT unit 105, the loop filter 107, the coding parameter determination unit 110, and the prediction parameter coding unit 111 may be realized by a computer. In that case, this configuration may be realized by recording a program for realizing such control functions on a computer-readable recording medium and causing a computer system to read the program recorded on the recording medium for execution. Note that it is assumed that the “computer system” mentioned here refers to a computer system built into either the image coding device 11 or the image decoding device 31, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system. Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Part or all of the image coding device 11 and the image decoding device 31 in the above-described embodiments may be realized as an integrated circuit such as a Large Scale Integration (LSI). Each function block of the image coding device 11 and the image decoding device 31 may be individually realized as processors, or part or all may be integrated into processors. Furthermore, a circuit integration technique is not limited to the LSI, and may be realized with a dedicated circuit or a general-purpose processor. Furthermore, in a case where with advances in semiconductor technology, a circuit integration technology with which an LSI is replaced appears, an integrated circuit based on the technology may be used.

The embodiment of the disclosure has been described in detail above referring to the drawings, but the specific configuration is not limited to the above embodiments and various amendments can be made to a design that fall within the scope that does not depart from the gist of the disclosure.

### Application Examples

The above-mentioned image coding device 11 and the image decoding device 31 can be utilized being installed to various apparatuses performing transmission, reception, recording, and regeneration of videos. Note that, videos may be natural videos imaged by cameras or the like, or may be artificial videos (including CG and GUI) generated by computers or the like.

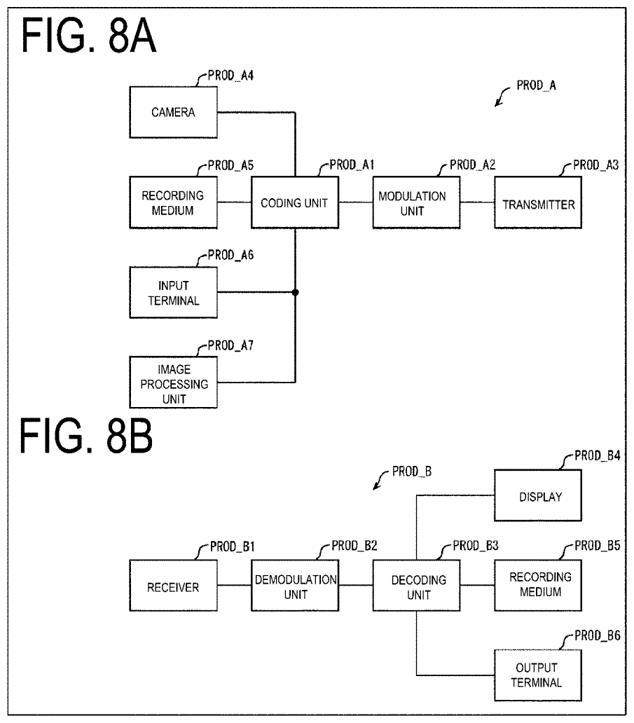

First, referring to FIGS. 8A and 8B, it will be described that the above-mentioned image coding device 11 and the image decoding device 31 can be utilized for transmission and reception of videos.

FIG. 8A is a block diagram illustrating a configuration of a transmitting apparatus PROD_A installed with the image coding device 11. As illustrated in FIG. 8A, the transmitting apparatus PROD_A includes a coding unit PROD_A1 which obtains coded data by coding videos, a modulation unit PROD_A2 which obtains modulating signals by modulating carrier waves with the coded data obtained by the coding unit PROD_A1, and a transmitter PROD_A3 which transmits the modulating signals obtained by the modulation unit PROD_A2. The above-mentioned image coding device 11 is utilized as the coding unit PROD_A1.

The transmitting apparatus PROD_A may further include a camera PROD_A4 imaging videos, a recording medium PROD_A5 for recording videos, an input terminal PROD_A6 to input videos from the outside, and an image processing unit A7 which generates or processes images, as sources of supply of the videos input into the coding unit PROD_A1. In FIG. 8A, although the configuration where the transmitting apparatus PROD_A includes all of these is exemplified, some may be omitted.

Note that the recording medium PROD_A5 may record videos which are not coded, or may record videos coded in a coding scheme for record different than a coding scheme for transmission. In the latter case, a decoding unit (not illustrated) to decode coded data read from the recording medium PROD_A5 according to coding scheme for recording may be interleaved between the recording medium PROD_A5 and the coding unit PROD_A1.

FIG. 8B is a block diagram illustrating a configuration of a receiving apparatus PROD_B installed with the image decoding device 31. As illustrated in FIG. 8B, the receiving apparatus PROD_B includes a receiver PROD_B1 which receives modulating signals, a demodulation unit PROD_B2 which obtains coded data by demodulating the modulating signals received by the receiver PROD_B1, and a decoding unit PROD_B3 which obtains videos by decoding the coded data obtained by the demodulation unit PROD_B2. The above-mentioned image decoding device 31 is utilized as the decoding unit PROD_B3.

The receiving apparatus PROD_B may further include a display PROD_B4 displaying videos, a recording medium PROD_B5 to record the videos, and an output terminal PROD_B6 to output videos outside, as the supply destination of the videos output by the decoding unit PROD_B3. In FIG. 8B, although the configuration that the receiving apparatus PROD_B includes these all is exemplified, a part may be omitted.

Note that the recording medium PROD_B5 may record videos which are not coded, or may record videos which are coded in a coding scheme different from a coding scheme for transmission. In the latter case, a coding unit (not illustrated) to code videos acquired from the decoding unit PROD_B3 according to a coding scheme for recording may be interleaved between the decoding unit PROD_B3 and the recording medium PROD_B5.

Note that the transmission medium transmitting modulating signals may be wireless or may be wired. The transmission aspect to transmit modulating signals may be broadcasting (here, referred to as the transmission aspect where the transmission target is not specified beforehand) or may be telecommunication (here, referred to as the transmission aspect that the transmission target is specified beforehand). Thus, the transmission of the modulating signals may be realized by any of radio broadcasting, cable broadcasting, radio communication, and cable communication.

For example, broadcasting stations (broadcasting equipment, and the like)/receiving stations (television receivers, and the like) of digital terrestrial television broadcasting is an example of transmitting apparatus PROD_A/receiving apparatus PROD_B transmitting and/or receiving modulating signals in radio broadcasting. Broadcasting stations (broadcasting equipment, and the like)/receiving stations (television receivers, and the like) of cable television broadcasting are an example of transmitting apparatus PROD_A/receiving apparatus PROD_B transmitting and/or receiving modulating signals in cable broadcasting.

Servers (work stations, and the like)/clients (television receivers, personal computers, smartphones, and the like) for Video On Demand (VOD) services, video hosting services using the Internet and the like are an example of transmitting apparatus PROD_A/receiving apparatus PROD_B transmitting and/or receiving modulating signals in telecommunication (usually, either radio or cable is used as transmission medium in the LAN, and cable is used for as transmission medium in the WAN). Here, personal computers include a desktop PC, a laptop type PC, and a graphics tablet type PC. Smartphones also include a multifunctional portable telephone terminal.

Note that a client of a video hosting service has a function to code a video imaged with a camera and upload the video to a server, in addition to a function to decode coded data downloaded from a server and to display on a display. Thus, a client of a video hosting service functions as both the transmitting apparatus PROD_A and the receiving apparatus PROD_B.

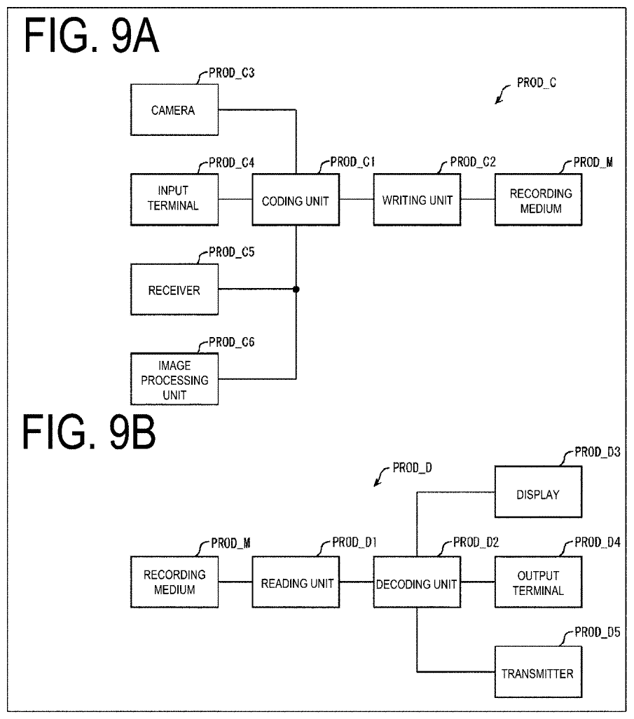

Next, referring to FIGS. 9A and 9B, it will be described that the above-mentioned image coding device 11 and the image decoding device 31 can be utilized for recording and regeneration of videos.

FIG. 9A is a block diagram illustrating a configuration of a recording apparatus PROD_C installed with the above-mentioned image coding device 11. As illustrated in FIG. 9A, the recording apparatus PROD_C includes a coding unit PROD_C1 which obtains coded data by coding a video, and a writing unit PROD_C2 which writes the coded data obtained by the coding unit PROD_C1 in a recording medium PROD_M. The above-mentioned image coding device 11 is utilized as the coding unit PROD_C1.

Note that the recording medium PROD_M may be (1) a type built in the recording apparatus PROD_C such as Hard Disk Drive (HDD) or Solid State Drive (SSD), may be (2) a type connected to the recording apparatus PROD_C such as an SD memory card or a Universal Serial Bus (USB) flash memory, and may be (3) a type loaded in a drive apparatus (not illustrated) built in the recording apparatus PROD_C such as Digital Versatile Disc (DVD) or Blu-ray Disc (BD: trade name).

The recording apparatus PROD_C may further include a camera PROD_C3 imaging a video, an input terminal PROD_C4 to input the video from the outside, a receiver PROD_C5 to receive the video, and an image processing unit PROD_C6 which generates or processes images, as sources of supply of the video input into the coding unit PROD_C1. In FIG. 9A, although the configuration that the recording apparatus PROD_C includes these all is exemplified, a part may be omitted.

Note that the receiver PROD_C5 may receive a video which is not coded, or may receive coded data coded in a coding scheme for transmission different from a coding scheme for recording. In the latter case, a decoding unit (not illustrated) for transmission to decode coded data coded in a coding scheme for transmission may be interleaved between the receiver PROD_C5 and the coding unit PROD_C1.

Examples of such recording apparatus PROD_C include a DVD recorder, a BD recorder, a Hard Disk Drive (HDD) recorder, and the like (in this case, the input terminal PROD_C4 or the receiver PROD_C5 is the main source of supply of a video). A camcorder (in this case, the camera PROD_C3 is the main source of supply of a video), a personal computer (in this case, the receiver PROD_C5 or the image processing unit C6 is the main source of supply of a video), a smartphone (in this case, the camera PROD_C3 or the receiver PROD_C5 is the main source of supply of a video), or the like is an example of such recording apparatus PROD_C.

FIG. 9B is a block diagram illustrating a configuration of a regeneration apparatus PROD_D installed with the above-mentioned image decoding device 31. As illustrated in FIG. 9B, the regeneration apparatus PROD_D includes a reading unit PROD_D1 which reads coded data written in the recording medium PROD_M, and a decoding unit PROD_D2 which obtains a video by decoding the coded data read by the reading unit PROD_D1. The above-mentioned image decoding device 31 is utilized as the decoding unit PROD_D2.

Note that the recording medium PROD_M may be (1) a type built into the regeneration apparatus PROD_D such as HDD or SSD, may be (2) a type connected to the regeneration apparatus PROD_D such as an SD memory card or a USB flash memory, and may be (3) a type loaded in a drive apparatus (not illustrated) built into the regeneration apparatus PROD_D such as DVD or BD.

The regeneration apparatus PROD_D may further include a display PROD_D3 displaying a video, an output terminal PROD_D4 to output the video to the outside, and a transmitter PROD_D5 which transmits the video, as the supply destination of the video output by the decoding unit PROD_D2. In FIG. 9B, although the configuration that the regeneration apparatus PROD_D includes these all is exemplified, a part may be omitted.

Note that the transmitter PROD_D5 may transmit a video which is not coded, or may transmit coded data coded in a coding scheme for transmission different than a coding scheme for recording. In the latter case, a coding unit (not illustrated) to code a video in a coding scheme for transmission may be interleaved between the decoding unit PROD_D2 and the transmitter PROD_D5.

Examples of such regeneration apparatus PROD_D include a DVD player, a BD player, an HDD player, and the like (in this case, the output terminal PROD_D4 to which a television receiver, and the like is connected is the main supply target of the video). A television receiver (in this case, the display PROD_D3 is the main supply target of the video), a digital signage (also referred to as an electronic signboard or an electronic bulletin board, and the like, the display PROD_D3 or the transmitter PROD_D5 is the main supply target of the video), a desktop PC (in this case, the output terminal PROD_D4 or the transmitter PROD_D5 is the main supply target of the video), a laptop type or graphics tablet type PC (in this case, the display PROD_D3 or the transmitter PROD_D5 is the main supply target of the video), a smartphone (in this case, the display PROD_D3 or the transmitter PROD_D5 is the main supply target of the video), or the like is an example of such regeneration apparatus PROD_D.

### Realization as Hardware and Realization as Software

Each block of the above-mentioned image decoding device 31 and the image coding device 11 may be realized as a hardware by a logical circuit formed on an integrated circuit (IC chip), or may be realized as a software using Central Processing Unit (CPU).

In the latter case, each apparatus includes a CPU performing a command of a program to implement each function, a Read Only Memory (ROM) storing the program, a Random Access Memory (RAM) developing the program, and a storage apparatus (recording medium) such as a memory storing the program and various data, and the like. The purpose of the embodiments of the disclosure can be achieved by supplying, to each of the apparatuses, the recording medium recording readably the program code (execution form program, intermediate code program, source program) of the control program of each of the apparatuses which is a software implementing the above-mentioned functions with a computer, and reading and performing the program code recorded in the recording medium with the computer (or a CPU or an MPU).

For example, as the recording medium, a tape such as a magnetic tape or a cassette tape, a disc including a magnetic disc such as a floppy (trade name) disk/a hard disk and an optical disc such as a Compact Disc Read-Only Memory (CD-ROM)/Magneto-Optical disc (MO disc)/Mini Disc (MD)/Digital Versatile Disc (DVD)/CD Recordable (CD-R)/Blu-ray Disc (trade name), a card such as an IC card (including a memory card)/an optical memory card, a semiconductor memory such as a mask ROM/Erasable Programmable Read-Only Memory (EPROM)/Electrically Erasable and Programmable Read-Only Memory (EEPROM: trade name)/a flash ROM, or a Logical circuits such as a Programmable logic device (PLD) or a Field Programmable Gate Array (FPGA) can be used.

Each of the apparatuses is configured to be connectable with a communication network, and the program code may be supplied through the communication network. This communication network may be able to transmit a program code, and is not specifically limited. For example, the Internet, the intranet, the extranet, Local Area Network (LAN), Integrated Services Digital Network (ISDN), Value-Added Network (VAN), a Community Antenna television/Cable Television (CATV) communication network, Virtual Private Network, telephone network, a mobile communication network, satellite communication network, and the like are available. A transmission medium constituting this communication network may also be a medium which can transmit a program code, and is not limited to a particular configuration or a type. For example, a cable communication such as Institute of Electrical and Electronic Engineers (IEEE) 1394, a USB, a power line carrier, a cable TV line, a phone line, an Asymmetric Digital Subscriber Line (ADSL) line, and a radio communication such as infrared ray such as Infrared Data Association (IrDA) or a remote control, Bluetooth (trade name), IEEE 802.11 radio communication, High Data Rate (HDR), Near Field Communication (NFC), Digital Living Network Alliance (DLNA: trade name), a cellular telephone network, a satellite channel, a terrestrial digital broadcast network are available. Note that the embodiments of the disclosure can be also realized in the form of computer data signals embedded in a carrier wave where the program code is embodied by electronic transmission.

The embodiments of the disclosure are not limited to the above-mentioned embodiments, and various modifications are possible within the scope of the claims. Thus, embodiments obtained by combining technical means modified appropriately within the scope defined by claims are included in the technical scope of the disclosure.

### CROSS-REFERENCE OF RELATED APPLICATION

This application claims the benefit of priority to JP 2017-051342 filed on Mar. 16, 2017 and JP 2016-244900 filed on Dec. 16, 2016, the entire contents of which are incorporated herein by reference.

### INDUSTRIAL APPLICABILITY

The embodiments of the disclosure can be preferably applied to an image decoding device to decode coded data where graphics data is coded, and an image coding device to generate coded data where graphics data is coded. The embodiments of the disclosure can be preferably applied to a data structure of coded data generated by the image coding device and referred to by the image decoding device.

### REFERENCE SIGNS LIST

10 CN Information decoding unit (Split information decoding unit)
11 Image coding device
13 TT Information decoding unit
22 TU decoding unit
31 Image decoding device
32 Context determination unit
41 Image display apparatus

1-24. (canceled)

25. An image decoding device for decoding a picture for each block, the image decoding device comprising:
a context determination unit configured to determine, with reference to a result of comparison of split-related information of at least one neighboring block adjacent to the target block, a context of split information of the target block; and
a split information decoding unit configured to decode the split information of the target block by using the context determined by the context determination unit.

26. The image decoding device according to claim 25,
wherein the split information is a split flag for indicating whether or not to split the target block, and
the split-related information is a block size.

27. An image decoding device for decoding a picture for each block, the image decoding device comprising:
a context determination unit configured to determine a context of split information of a target block with reference to a situation of at least one neighboring block adjacent to the target block; and
a split information decoding unit configured to decode the split information of the target block by using the context determined by the context determination unit.

28. The image decoding device according to claim 27,
wherein the split information is a split flag for indicating whether or not to split the target block, and
the context determination unit refers to a size of the at least one neighboring block and identifies the split situation of the at least one neighboring block.

29. The image decoding device according to claim 27,
wherein the split information is a flag indicating whether the target block is split or not, and
the context determination unit refers to a size of the at least one neighboring block and identifies the split situation of the at least one neighboring block.

30. An image coding device for coding a picture for each block, the image coding device comprising:
a context determination unit configured to determine a context of split information of a target block with reference to a situation of at least one neighboring block adjacent to the target block; and
a split information coding unit configured to code the split information of the target block by using the context determined by the context determination unit.

31. The image decoding device according to claim 27, wherein the neighboring block is the left block and the top block of the target block.

32. The image decoding device according to claim 29, wherein the neighboring block is the left block and the top block of the target block.
